(19) United States
(12) Patent Application Publication
(10) Pub. No.: US 2011/0022993 A1
(43) Pub. Date: Jan. 27, 2011

(54) SCREEN SAVER CONTROL APPARATUS AND METHOD

(75) Inventors: Takashi OHNO, Kawasaki (JP); Ryuichi Matsukura, Kawasaki (JP)

Correspondence Address: Fujitsu Patent Center;Fujitsu Management Services of America, Inc., 2318 Mill Road, Suite 1010, Alexandria, VA, 22314, US

(73) Assignee: FUJITSU LIMITED, Kawasaki-shi (JP)

(21) Appl. No.: 12/843,090

(22) Filed: Jul. 26, 2010

(30) Foreign Application Priority Data
Jul. 27, 2009 (JP) 2009-174685

(51) Int. Cl. G06F 9/455; G06F 3/048

(52) U.S. Cl. 715/867; 718/1

(57) ABSTRACT

A computer-based device for operating a virtual machine, the computer apparatus including: a determination unit for determining, based on operation information of a terminal apparatus operating the virtual machine, whether the virtual machine has activated a screen saver or has stopped the screen saver; and a screen saver control information transmission unit for outputting control information to the terminal apparatus operating the virtual machine, on the basis of a determination result generated by the determination unit, the control information indicating that the terminal apparatus operating the virtual machine has activated the screen saver or has stopped the screen saver.

### CROSS-REFERENCE TO RELATED APPLICATIONS

This application is based upon and claims the benefit of priority of the prior Japanese Patent Application No. 2009-174685, filed on Jul. 27, 2009, the entire contents of which are incorporated herein by reference.

### FIELD

The present invention relates to a screen saver control apparatus and a screen saver control method.

### BACKGROUND

In recent years, a higher performance of a hardware resource in a computer such as, for example, a Central Processing Unit (CPU) or a memory has advanced, and a complicated processing can be executed in a shorter period of time. However, in a case where the computer is used for a simple operation such as a document creation, the performance of the hardware resource is not sufficiently utilized, and it is therefore desired that an excess performance of the hardware resource is efficiently utilized. In view of the above, a virtualization technology is proposed for virtually dividing the hardware resource into a plurality of partitions. According to this virtualization technology, a computer is constructed in such a manner that the hardware resource is virtually divided into a plurality of partitions, with separate computing taking place in in the respective partitions. That is, the plurality of partitions of the computer's hardware resource represent a plurality of virtual computers (hereinafter, each of which will be referred to as a Virtual Machine (VM)) that can be operated on a single computer.

On the respective VMs, it is possible to run different Operating Systems (OSs). Therefore, a plurality of different OSs can be run on the single computer. With this configuration, by consolidating computers owned by respective users into a single computer, it is possible to save installation spaces for the computers or reduce consumption power or the like. Also, by consolidating computer environments for the users, it is possible to reduce maintenance costs through a central control.

The above-mentioned virtualization technology can be used for a thin-client information processing system. The information processing system using such virtualization technology is provided with terminal apparatuses operated by the respective users and a server apparatus connected to the terminal apparatuses via a network. In the server apparatus, a plurality of VMs is operated, and a separate OS can run for each VM. From the terminal apparatus at hand, the respective users can operate the VMs provided by the server apparatus via the network.

The thin-client terminal apparatus and the general OS running on the corresponding VM are provided with a function of activating a screen saver. By activating the screen saver, it is possible to reduce the severity of, if not prevent, a screen burning. Screen burning can occur when an identical screen is displayed on a monitor for a long period of time in a case where no operation is performed for a certain period of time. The occurrence of screen burning can be the result of a user not being physically present at (i.e., the user not attending to) the thin-client terminal apparatus for the certain period of time. As such, activating the screen saver can discourage, if not prevent, a third person peeping at information displayed on the unattended thin-client terminal apparatus.

With regard to this activation of the screen saver, a method is proposed in which drive and control are performed from the apparatus connected via the network on one side as described above so that the screen saver is activated on the other side. For example, a method is proposed in which when image data read by a scanner is transferred to a computer, drive and control are performed from the scanner so that the screen saver is activated on the computer (for example, Japanese Unexamined Patent Application Publication No. 2007-282052). In this case, at the time of the transfer of the image data, it is possible to avoid a situation in which the transferred image data is displayed on the screen of the computer and viewed by a third person.

Also, in an environment where another apparatus (remote machine) is operated from the terminal apparatus via the network, a method of instructing the remote machine from the terminal apparatus to activate the screen saver is proposed (for example, Japanese Unexamined Patent Application Publication No. 2003-85135). According to this method, a screen output from the remote machine is transferred to the terminal apparatus, the screen is output to the user, and the same screen is displayed on the remote machine and the terminal apparatus. For this reason, by executing the screen saver only on the remote machine, it is possible to avoid a situation via the remote machine in which the operation screen of the user on the terminal apparatus is viewed by a third person.

### SUMMARY

According to an aspect of the present invention, a computer apparatus, for operating a virtual machine, includes: a determination unit for determining, based upon operation information of a terminal apparatus operating the virtual machine, whether the virtual machine has activated a screen saver or has stopped the screen saver;

and a screen saver control information transmission unit for outputting control information to the terminal apparatus operating the virtual machine, on the basis of a determination result generated by the determination unit, the control information indicating that the terminal apparatus operating the virtual machine has activated the screen saver or has stopped the screen saver.

Advantages of the present invention will be realized and attained via the elements and combinations particularly pointed out in the claims.

It is to be understood that both the foregoing general description and the following detailed description are exemplary and explanatory and are not restrictive of the present invention, as claimed.

### BRIEF DESCRIPTION OF DRAWINGS

FIG. 1 schematically shows an information processing system according to a first embodiment of the present invention;

FIG. 2 is a block diagram showing a configuration of the information processing system according to the first embodiment;

FIG. 3 is a function block diagram showing a function of the information processing system according to the first embodiment;

FIG. 4 shows an example of a setting screen displayed on a monitor of a terminal apparatus;

FIG. 5 is a flow chart showing a processing procedure executed by the terminal apparatus when a remote operation is started and stopped;

FIG. 6 is a flow chart showing a processing procedure executed by a remote machine when the remote operation is started and stopped;

FIG. 7 is a flow chart showing a processing procedure executed by the terminal apparatus when setting information is set;

FIG. 8 is a flow chart showing a processing procedure executed by a VM of the remote machine when the setting information is set;

FIG. 9 is a flow chart showing a processing procedure executed by the VM of the remote machine when a screen saver is activated and stopped;

FIG. 10 is a flow chart showing a processing procedure executed by the terminal apparatus when the screen saver is activated and stopped;

FIG. 11 is a function block diagram showing a function of an information processing system according to a second embodiment of the present invention;

FIG. 12 is a flow chart showing a processing procedure executed by the terminal apparatus when the screen saver is activated and stopped;

FIG. 13 is a flow chart showing a processing procedure executed by the remote machine when the screen saver is activated and stopped;

FIG. 14 is a function block diagram showing a function of a remote machine in an information processing system according to a third embodiment of the present invention;

FIG. 15 shows an example of the setting screen displayed on the monitor of the terminal apparatus;

FIG. 16 is a flow chart showing a processing procedure executed by the terminal apparatus when the remote operation is started and stopped;

FIG. 17 is a flow chart showing a processing procedure executed by the remote machine when the remote operation is started and stopped;

FIG. 18 is a flow chart showing a processing procedure executed by the VM of the remote machine when the setting information is set;

FIG. 19 is a flow chart showing a processing procedure executed by the VM of the remote machine when the screen saver is activated and stopped;

FIG. 20 is a function block diagram showing a function of an information processing system according to a fourth embodiment of the present invention;

FIG. 21 is a flow chart showing a processing procedure executed by the terminal apparatus at the time of application monitoring;

FIG. 22 is a flow chart showing a processing procedure executed by the VM of the remote machine at the time of the application monitoring;

FIG. 23 is a block diagram showing a configuration of a terminal apparatus in an information processing system according to a fifth embodiment of the present invention;

FIG. 24 is a function block diagram showing a function of the terminal apparatus in the information processing system according to the fifth embodiment;

FIG. 25 is a flow chart showing a processing procedure executed by the terminal apparatus when a monitor displaying a window for a remote is identified; and

FIG. 26 is a flow chart showing a processing procedure executed by the terminal apparatus when the screen saver is activated and stopped.

### DESCRIPTION OF EMBODIMENTS

For example, as in Japanese Unexamined Patent Application Publication No. 2007-282052 or Japanese Unexamined Patent Application Publication No. 2003-85135, in a case where a screen saver of a certain VM is activated from another apparatus, a machine resource necessary for a processing can be reduced in general. If the machine resource used in the certain VM is left over, the left over machine resource can be provided to other VMs, and it is possible to effectively utilize the machine resource. However, the screen saver itself consumes a CPU resource to no small extent. In the case of a screen saver having high processing load for displaying a three-dimensional (3D) image or the like, a processing operation of a computer itself is slowed, which may affect other VMs.

Also, according to Japanese Unexamined Patent Application Publication No. 2003-85135, a screen saver is activated through an operation by a user from a terminal apparatus. For this reason, a state is established in which, although the screen saver is executed in a remote machine, the screen saver is not executed in the terminal apparatus. Therefore, in a case where the screen saver is activated in the terminal apparatus, for each of the remote machine and the terminal apparatus, the screen saver is separately operated, and the resource such as the CPU is wastefully consumed. Furthermore, also while the screen saver is running, the VM screen is kept being transmitted to the terminal apparatus via a network, and a network resource is also wastefully consumed.

In view of the above, a screen saver control apparatus and a control method are provided in which load during the execution of the screen saver can be reduced.

Hereinafter, a description will be given of example embodiments of a screen saver control system according to the present invention with reference to the drawings.

### First Embodiment

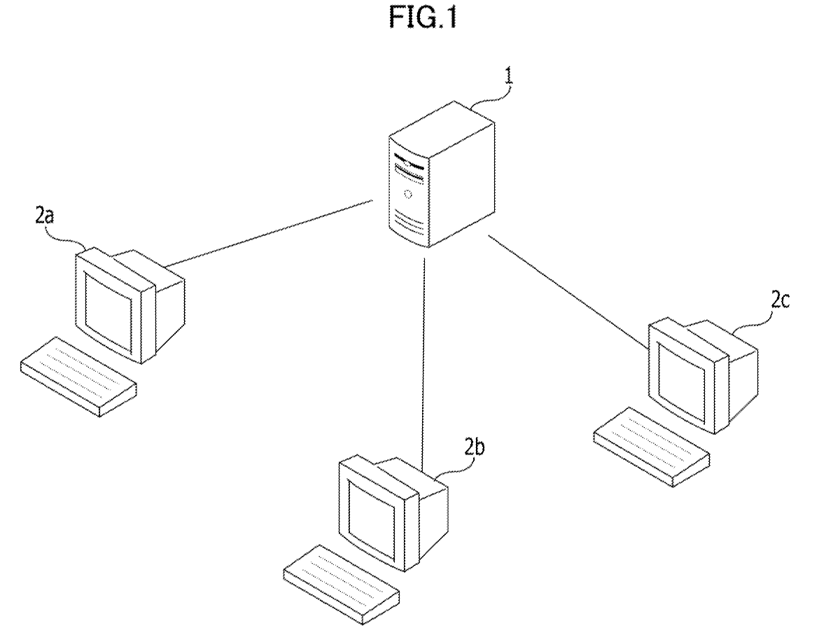

FIG. 1 schematically shows an information processing system according to the present first embodiment. An information processing system according to the present first embodiment (screen saver control system) is provided with a single remote machine (a second information processing apparatus, an image processing apparatus) 1 and a plurality of terminal apparatuses (first information processing apparatuses, image display apparatuses) 2a, 2b, and 2c. The remote machine 1 and the terminal apparatuses 2a, 2b, and 2c are connected via a network such as Local Area Network (LAN) or Wide Area Network (WAN). It should be noted that the number of the terminal apparatuses 2a, 2b, and 2c, a connection method for the remote machine 1 and the terminal apparatuses 2a, 2b, and 2c, and the like can be appropriately changed. Also, the remote machine 1 and the terminal apparatuses 2a, 2b, and 2c may be connected in any one of a wired manner and a wireless manner.

The remote machine 1 is composed of, for example, a server apparatus, a personal computer, or the like which is provided with a communication function, and a plurality of VMs (according to the present embodiment, three VMs) are operated through a virtualization technology. The VM is a virtual computer for independently executing an OS and an application in a similar manner as a physical computer does. Therefore, the remote machine 1 virtually operates a plurality of computers. The respective VMs are allocated with the connected terminal apparatuses 2a, 2b, and 2c and operated by the terminal apparatuses 2a, 2b, and 2c.

The terminal apparatuses 2a, 2b, and 2c are composed of computers provided with a monitor, a key board, a mouse, and the like and configured to independently execute the OS, the application, and the like. Also, the terminal apparatuses 2a, 2b, and 2c perform a data communication with the remote machine 1 via the network. The terminal apparatuses 2a, 2b, and 2c are connected to the operation target VMs via the network so as to be able to operate the respective VMs. After that, the terminal apparatuses 2a, 2b, and 2c accept operations with respect to the VMs from the key board and the mouse. The terminal apparatuses 2a, 2b, and 2c transmit the accepted operations to the respective VMs of the remote machine 1 and receive processing results with respect to the operations. The terminal apparatuses 2a, 2b, and 2c display the received processing results, operation states of the VMs, or the like on a monitor.

According to the present first embodiment, the terminal apparatuses 2a, 2b, and 2c display a basic operation screen (so-called desk top) of the OS executed by itself on the entire monitor. Then, the terminal apparatuses 2a, 2b, and 2c display a window whose size is adjustable on a part of the screen (hereinafter, which will be referred to as window for remote) and display the above-mentioned processing results of the VMs in the window for the remote.

The terminal apparatuses 2a, 2b, and 2c can perform execution of the screen saver. In a case where the screen saver is activated, the terminal apparatuses 2a, 2b, and 2c display a screen saver screen on the entire screen. A determination as to whether or not the terminal apparatuses 2a, 2b, and 2c execute the screen saver is performed in the respective VMs of the remote machine 1. The respective VMs of the remote machine 1 cause the terminal apparatuses 2a, 2b, and 2c to activate the screen saver in a case where operations are not input for a certain period of time with respect to the respective VMs of the remote machine 1 from the terminal apparatuses 2a, 2b, and 2c. As the screen saver is activated, even in a case where the users of the terminal apparatuses 2a, 2b, and 2c leave their desks or the like, it is possible to reduce the likelihood of, if not prevent, a third person peeping at information displayed on the unattended thin-client terminal apparatus terminal apparatuses 2a, 2b, and 2c.

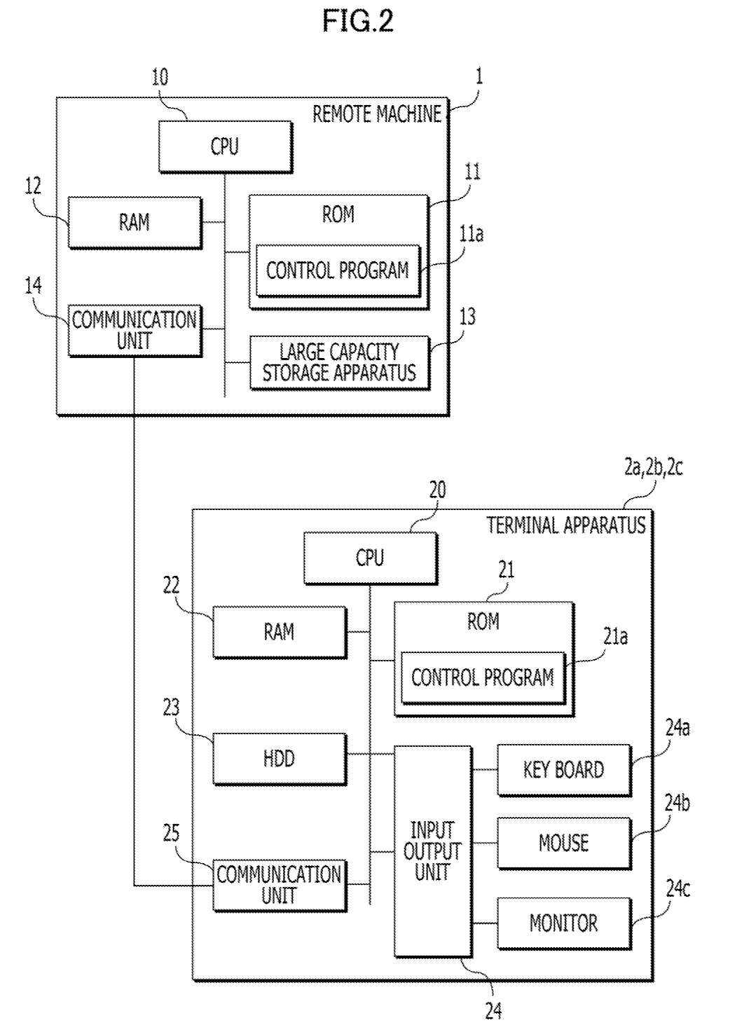

FIG. 2 is a block diagram showing a configuration of the information processing system according to the present first embodiment.

The remote machine 1 is provided with hardware respective units including a CPU 10, a Read Only Memory (ROM) 11, a Random Access Memory (RAM) 12, a large capacity storage apparatus 13, a communication unit 14 for establishing a connection to a network, and the like. These hardware respective units are mutually connected via a bus.

The CPU 10 appropriately reads out a control program which is previously stored in the ROM 11, the large capacity storage apparatus 13, or the like onto the RAM 12 for the execution and also controls the above-mentioned hardware respective units. The ROM 11 previously stores a control program 11a which can be used by the remote machine 1 to operate as the image processing apparatus disclosed in the present application. The RAM 12 is, for example, a Static RAM (SRAM), a Dynamic RAM (DRAM), a flash memory, or the like. The RAM 12 temporarily stores various pieces of data generated at the time of the execution of the control program by the CPU 10.

The large capacity storage apparatus 13 is composed, for example, of a hard disk drive (hereinafter, which will be referred to as HDD). The large capacity storage apparatus 13 stores a Virtual Machine Monitor (VMM) program, a management OS program, a guest OS program, an application program, various pieces of data, and the like. The respective programs are control programs read out and executed by the CPU 10. The respective programs are read out and executed by the RAM 12 through the CPU 10. It should be noted that the respective programs may be stored in the ROM 11. Also, a mode may be adopted in which the control program 11a is installed into the large capacity storage apparatus 13 from external media such as a CD-ROM to be used.

The VMM program is a software program for realizing the virtualization technology for allowing the operation of the VM in the remote machine 1. The CPU 10 executes the VMM program after the activation of the remote machine 1 to start an operation as a virtual machine monitor (hereinafter, which will be referred to as VMM). As the CPU 10 operates as the VMM, the remote machine 1 is provided with a virtual environment in which the plurality of VMs can operate independently.

The management OS program is a software program for realizing a function of activating and stopping the VM on the virtual environment and a function of allocating resources to the VM and cancelling the allocation. After the activation of the remote machine 1, the CPU 10 executes the management OS program to start an operation as a management OS. The resources allocated to the VM are the CPU 10, the RAM 12, the large capacity storage apparatus 13, and the like.

The guest OS program is a software program for executing the OS on the VM. After the activation of the respective VMs, the CPU 10 executes the guest OS program to start an operation as an OS (hereinafter, which will be referred to as guest OS). The guest OS is, for example, Windows (registered trademark), Linux (registered trademark), or the like. The guest OS generates a display screen including Character-based User Interface (CUI), Graphical User Interface (GUI), or the like which should be displayed in accordance with the executed processing to be displayed on the virtual display apparatus provided by the VMM. Also, the guest OS accepts control signals from the virtual input apparatus provided by the VMM. Then, the guest OS functions as execution unit for executing various processings in accordance with the accepted control signals. When the terminal apparatuses 2a, 2b, and 2c are connected to the respective VMs, the display screen generated by the VM is sent to the terminal apparatuses 2a, 2b, and 2c and displayed on monitors of the terminal apparatuses 2a, 2b, and 2c. Also, the guest OS accepts control signals from the connected key board and mouse. Then, the guest OS functions as execution unit for executing various processings in accordance with the accepted control signals.

The application program is a software program executed by each guest OS. The remote machine 1 may read the application program from the external memory in which the application program is recorded and store the application program in the large capacity storage apparatus 13. Also, the remote machine 1 may download the application program via the network to be stored in the large capacity storage apparatus 13.

The terminal apparatuses 2a, 2b, and 2c are provided with hardware respective units including a CPU 20, a ROM 21, a RAM 22, an HDD 23, an input output unit 24, a communication unit 25 for establishing a connection to a network, and the like. These hardware respective units are mutually connected via the bus.

The CPU 20 appropriately reads out the control program previously stored in the ROM 21, the HDD 23, or the like onto the RAM 22 to execute the control program and also controls the operations of the above-mentioned hardware respective units. The ROM 21 previously stores an operation program 21a, various pieces of data, and the like. The RAM 22 is composed, for example, of the SRAM, the DRAM, the flash memory, or the like and configured to temporarily store various pieces of data generated at the time of the execution of the control program by the CPU 20. Also, the terminal apparatuses 2a, 2b, and 2c may be composed of thin-client terminals which have no storage apparatus like the HDD 23 and do not allow holding of the data when a power source is OFF.

To the input output unit 24, input and output apparatuses such as key board 24a, a mouse 24b, and a monitor 24c are connected. The input output unit 24 has, for example, a Universal Serial Bus (USB) port and a monitor connection port. Then, in the input output unit 24, transmission and reception of data are carried out among the key board 24a, the mouse 24b, and the monitor 24c connected via a USB cable and a cable for a monitor connection.

The key board 24a and the mouse 24b are provided with various operation detecting apparatuses for the user to operate the VMs operated in the terminal apparatuses 2a, 2b, and 2c and the remote machine 1. In a case where respective operation keys are operated by the user, the key board 24a and the mouse 24b output control signals corresponding to the operated operation keys.

The monitor 24c is composed of a liquid crystal monitor, a Cathode Ray Tube (CRT) monitor, or the like. The monitor 24c displays operation states of the terminal apparatuses 2a, 2b, and 2c, information input by the user, information of which the user should be notified, and the like. Also, the monitor 24c is operated in the connected remote machine 1 and displays various pieces of information while following the data sent from the VMs corresponding to its own terminal apparatuses 2a, 2b, and 2c.

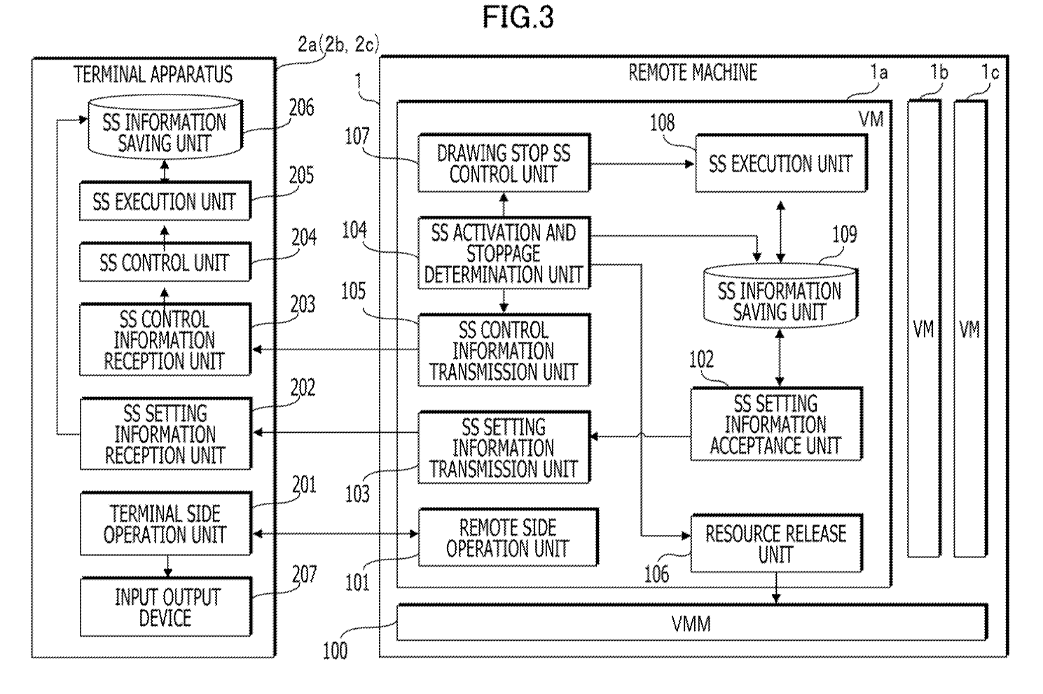

Hereinafter, in the above-mentioned information processing system, a description will be given of the functions realized by the remote machine 1 and the terminal apparatuses 2a, 2b, and 2c. FIG. 3 is a function block diagram showing a function of the information processing system according to the present first embodiment.

In a case where a power source of the remote machine 1 is turned ON and the activation of the hardware respective units in the remote machine 1 is completed, the CPU 10 gains a function of a VMM 100 by executing the VMM program. Next, the CPU 10 executes the management OS program to start the operation as the management OS and activates VMs 1a, 1b, and 1c. Also, the VMs 1a, 1b, and 1c may be activated in accordance with a request from the terminal apparatus.

The CPU 10 operating as the management OS starts to allocate the resources such as the CPU 10, the RAM 12, the large capacity storage apparatus 13, the terminal apparatuses 2a, 2b, and 2c, and the like to the activated VMs 1a, 1b, and 1c, for example. After the VMs 1a, 1b, and 1c are activated and allocated with the resources, the CPU 10 operating as the management OS executes the guest OS program. With this configuration, on the activated VMs 1a, 1b, and 1c, the operation of the guest OS is started. It should be noted that in FIG. 3, only the function of the VM 1a is illustrated (for the purposes of simplifying the drawing), but the same applies to the other VMs 1b and 1c. In addition, hereinafter, a case will be described in which the VM 1a and the terminal apparatus 2a are connected with each other, and the VM 1a is operated from the terminal apparatus 2a.

The VM 1a in which the guest OS is operated gains functions of a remote side operation unit 101, a screen saver (hereinafter, which will be referred to as SS) setting information acceptance unit 102, an SS setting information transmission unit 103, an SS activation and stoppage determination unit 104 (hereafter “determination unit 104”), an SS control information transmission unit 105, a resource release unit 106, a drawing stop SS control unit 107, an SS execution unit 108, an SS information saving unit 109, and the like while the CPU 10 allocated to the VM 1a executes the control program 11a stored in the ROM 11.

By executing the operation program 21a stored in the ROM 21, the terminal apparatus 2a gains functions of a terminal side operation unit 201, an SS setting information reception unit 202, an SS control information reception unit 203, an SS control unit 204, an SS execution unit 205, an SS information saving unit 206, and the like.

The terminal side operation unit 201 in the terminal apparatus 2a enables the operation of the VM 1a operating in the remote machine 1. The terminal side operation unit 201 performs data transmission and reception with an input output device 207. The input output device 207 are composed of the key board 24a, the mouse 24b, and the monitor 24c provided to the terminal apparatus 2a. The terminal side operation unit 201 accepts the operations from the key board 24a, the mouse 24b, and the like to the window for the remote to be transmitted to the VM 1a of the remote machine 1 as the operation information. Also, the terminal side operation unit 201 receives display information including image data from the VM 1a of the remote machine 1 to be displayed on the window for the remote of the monitor 24c.

The remote side operation unit 101 in the VM 1a of the remote machine 1 receives the operation information from the terminal side operation unit 201 and transmits display information related to a result with respect to the operation information to the terminal side operation unit 201. The VM 1a is provided with a virtual screen (hereinafter, which will be referred to as virtual monitor) and performs drawing of the image data displayed on this virtual monitor. The remote side operation unit 101 transmits this drawn image data to the terminal side operation unit 201 as display information. With this configuration, the virtual monitor in the VM 1a is synchronized with the monitor 24c of the terminal apparatus 2a, and the same image is displayed on the respective monitors. Also, the data transmitted to the terminal side operation unit 201 may be command data to be drawn on the virtual monitor. In the terminal side operation unit 201, the drawing is carried out on the basis of the received command data.

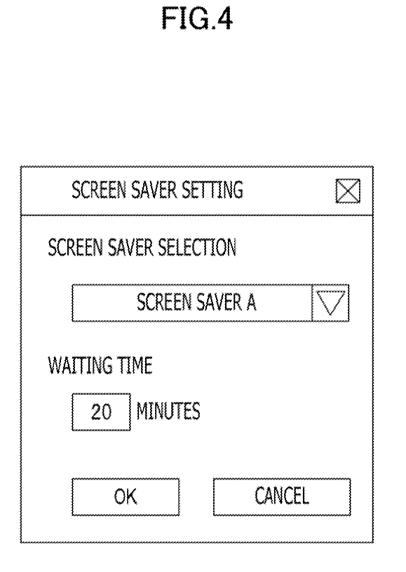

The SS setting information acceptance unit 102 in the remote machine 1 accepts setting information related to the screen saver. The setting information is input, for example, while following a setting screen displayed in the window for the remote of the monitor 24c of the terminal apparatus 2a. FIG. 4 shows an example of the setting screen displayed on the monitor 24c of the terminal apparatus 2a. On the setting screen, a type of the screen saver to be activated and a waiting time until the screen saver is activated (i.e., a threshold amount of time that must elapse before the screen saver is activated) are set. The waiting time is a period of time from when the VM 1a of the remote machine 1 receives the operation information from the terminal apparatus 2a until when the VM 1a receives the next instance of operation information. The VM 1a of the remote machine 1 activates the screen saver in a case where the VM 1a does not receive the operation information from the terminal apparatus 2a for a period of time longer than the set time. The SS setting information acceptance unit 102 receives the setting information input while following a setting screen shown in FIG. 4 from the terminal apparatus 2a via the remote side operation unit 101. The SS setting information acceptance unit 102 saves the accepted setting information in the SS information saving unit 109 and also outputs the setting information to the SS setting information transmission unit 103. It should be noted that the synchronization setting may be carried out on the remote machine 1 side.

The SS setting information transmission unit 103 transmits the setting information output from the SS setting information acceptance unit 102 to the SS setting information reception unit 202 in the terminal apparatus 2a. The SS setting information reception unit 202 receives the setting information transmitted from the SS setting information transmission unit 103 to be saved in the SS information saving unit 206. As a result, it is possible to save the same setting information in the SS information saving unit 109 and the SS information saving unit 206. This setting information may also include a screen saver program newly installed into the VM 1a of the remote machine 1.

The determination unit 104 in the VM 1a of the remote machine 1 determines activation or stoppage of the screen saver on the basis of the setting information saved in the SS information saving unit 109. For example, in a case where the operation information is not received from the terminal apparatus 2a for a certain period of time or longer, the determination unit 104 activates the screen saver. Also, in a case where the operation information is received from the terminal apparatus 2a, the determination unit 104 stops the screen saver. The determination unit 104 outputs the determination result to the SS control information transmission unit 105, the resource release unit 106, and the drawing stop SS control unit 107.

The SS control information transmission unit 105 transmits the control information to the SS control information reception unit 203 in the terminal apparatus 2a on the basis of the determination result output from the determination unit 104. The control information is information for activating the screen saver (hereinafter, which will be referred to as activation information) or information for stopping the screen saver (hereinafter, which will be referred to as stoppage information). The SS control information reception unit 203 outputs the control information received from the SS control information transmission unit 105 to the SS control unit 204.

The SS control unit 204 drives and controls the SS execution unit 205 while following the control information output from the SS control information reception unit 203. In a case where the control information is the activation information, the SS control unit 204 causes the SS execution unit 205 to obtain the setting information on the specified screen saver from the SS information saving unit 206 to activate the screen saver. With this configuration, a screen saver image is displayed on the monitor in the terminal apparatuses 2a, 2b, and 2c. In a case where the control information is the stoppage information, the SS control unit 204 causes the SS execution unit 205 to stop the activated screen saver.

The drawing stop SS control unit 107 drives and controls the SS execution unit 108 while following the control information output from the determination unit 104. In a case where the control information is the activation information, the drawing stop SS control unit 107 stops the drawing of the image data displayed on the virtual monitor and controls the SS execution unit 108 so that the screen saver image in a blank state is displayed on the virtual monitor. On the other hand, in a case where the control information is the stoppage information, the drawing stop SS control unit 107 controls the SS execution unit 108 so that the display of the screen saver image is stopped to start the drawing of the image data displayed on the virtual monitor.

The resource release unit 106 requests the VMM 100 to change the resource allocation while following the control information output from the determination unit 104. To be more specific, the resource release unit 106 requests the VMM 100 to change a weight value of the CPU 10. The weight value is a value indicating a use time for the CPU 10 used by the respective VMs 1a, 1b, and 1c, and the weight value is set at the time of the activation of the VMs 1a, 1b, and 1c. On the basis of a ratio of the respective values, the use time for the CPU 10 is changed. For example, at the time of the activation of the VMs 1a, 1b, and 1c, in a case where the weight values of 256, 128, and 64 are set, a ratio on the use time for the CPU 10 is 4:2:1. That is, the use time for the CPU 10 allocated to the VM 1a is 4/7 of the total. The resource release unit 106 requests the VMM 100 to perform the change of these weight values.

The VM 1a in which the screen saver is activated does not execute other processings, and therefore the processing load of the CPU 10 is alleviated. Also, as the screen saver image in the blank state is displayed on the virtual monitor by the drawing stop SS control unit 107, in contrast with a case in which the screen saver image is the three-dimensional image, it is possible to suppress the associated processing load of the CPU 10. For this reason, at the time of the activation of the screen saver, the use time for the CPU 10 (as used by the VM 1a) can be set smaller.

Therefore, in a case where the control information is the activation information, the resource release unit 106 requests the VMM 100 to set the weight value of the CPU 10 smaller. Also, in a case where the control information is the stop information, the resource release unit 106 requests the VMM 100 to restore the weight value of the CPU 10 to the original value. With this configuration, during the activation of the screen saver, the unnecessary resource can be released, and it is possible to effectively utilize the resource. In this example, the change in the CPU allocation rate is performed, but other memory amounts or other releasable machine resources such as input output devices may also be used.

Next, an operation of the information processing system according to the present first embodiment will be described on the basis of a flow chart. The operation to be described below is executed while the CPU 10 in the remote machine 1 and the CPU 20 in the terminal apparatus 2a (or 2b or 2c) execute the control programs stored in the ROM 11, the ROM 21, and the like. It should be noted that a description will be given hereinafter as it is supposed that the terminal apparatus 2a is connected to the VM 1a.

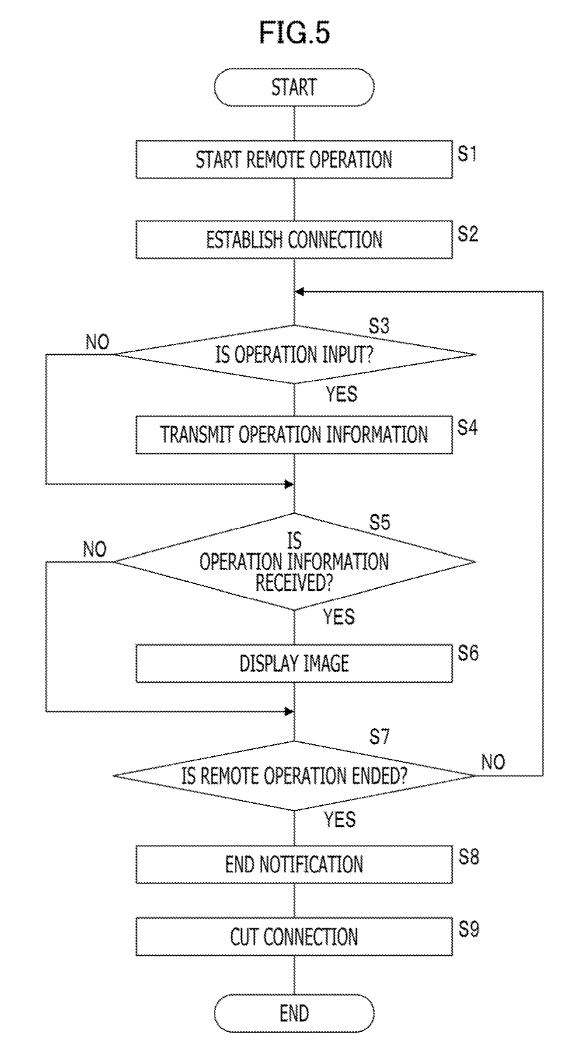

First, a processing at the time of the start and stop of a remote operation will be described. The remote operation refers to a state in which the terminal apparatus 2a is connected to the VM 1a of the remote machine 1, and the VM 1a operating in the remote machine 1 is operated from the terminal apparatus 2a. FIG. 5 is a flow chart showing a processing procedure executed by the terminal apparatus 2a at the time of the start and stop of the remote operation.

The CPU 20 starts the remote operation (S1). The remote operation is started, for example, when an application for the remote operation is executed. The CPU 20 may start to execute this dedicated application when the power source for the terminal apparatus 2a is turned ON or in response to the operation by the user. The CPU 20 gains the respective functions described with reference to FIG. 3 by starting the remote operation and executes the following processing.

The terminal side operation unit 201 establishes a communication connection with the VM 1a of the remote machine 1 (S2). The terminal side operation unit 201 may be connected to the VM 1a of the remote machine 1 at the same time as the start of the remote operation, and, for example, a user authentication is performed, and terminal side operation unit 201 may be connected to the VM 1a of the remote machine 1 in accordance with the authentication result. As the communication connection to the VM 1a of the remote machine 1 is established, the transmission and reception of the operation information, the display information, and the like can be carried out between the VM 1a of the remote machine 1 and the terminal apparatus 2a.

After the connection with the VM 1a of the remote machine 1 is established, the terminal side operation unit 201 determines whether or not the user operation is input to the window for the remote from the key board 24a or the mouse 24b (S3). In a case where the operation is input (S3: YES), the terminal side operation unit 201 transmits the operation information to the remote machine 1 (S4). After the transmission of the operation information or in a case where the operation is not input in S3 (S3: NO), the terminal side operation unit 201 determines whether or not the display information is received from the remote machine 1 (S5).

In a case where the display information is received (S5: YES), the terminal side operation unit 201 displays the image on the monitor 24c on the basis of the display information (S6). For example, when the remote operation is started, the terminal side operation unit 201 displays the window for the remote on a part of the screen of the monitor 24c and the image based on the display information in the window for the remote. After the image is displayed or in a case where the display information is not received in S5 (S5: NO), the terminal side operation unit 201 determines whether or not the remote operation is ended (S7). The remote operation is ended, for example, by ending the execution of the application for the remote operation.

In a case where the remote operation is not ended (S7: NO), the terminal side operation unit 201 executes the processing of S3 and subsequent steps. In a case where the remote operation is ended (S7: YES), the terminal side operation unit 201 notifies the remote machine 1 of the end of the remote operation (S8). Then, the terminal side operation unit 201 cuts off the connection with the remote machine 1 (S9), and the CPU 20 ends the present processing.

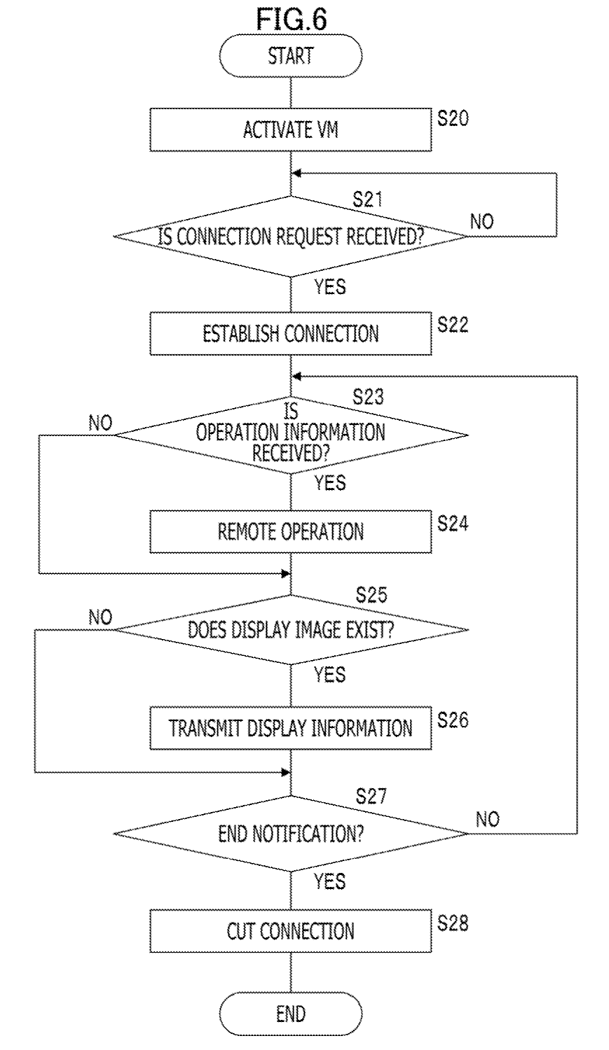

FIG. 6 is a flow chart showing a processing procedure executed by the remote machine 1 at the time of the start and stop of the remote operation.

After the power source for the remote machine 1 is turned ON and the activation of the hardware respective units in the remote machine 1 is completed, the CPU 10 sequentially executes the VMM program and the management OS program to activate the VMs 1a, 1b, and 1c (S20). Also, the VMs 1a, 1b, and 1c may be activated in accordance with a request from the terminal apparatus. After the activation, as the CPU 10 executes the guest OS program, the OS is operated on the VMs 1a, 1b, and 1c. Then, the VMs 1a, 1b, and 1c gains the respective functions described with reference to FIG. 3 and executes the following processing.

The remote side operation unit 101 determines whether or not the connection request from the terminal apparatus 2a is received (S21). In a case where the connection request is not received (S21: NO), the remote side operation unit 101 stands by until the connection request is received. In a case where the connection request is received (S21: YES), the remote side operation unit 101 establishes the connection with the terminal apparatus 2a which requests the communication connection (S22). The remote side operation unit 101 determines whether or not the operation information is received from the terminal apparatus 2a (S23). In a case where the operation information is received (S23: YES), the remote side operation unit 101 executes the remote operation by executing the processing based on the operation information (S24). In a case where the operation information is not received after the remote operation or in S22 (S23: NO), the remote side operation unit 101 determines whether or not the image that should be displayed exists (S25).

The image that should be displayed is, for example, an image indicating the processing result with respect to the remote operation, an image indicating a connection state with the terminal apparatus 2a or an operation state of the VM 1a, or the like. In a case where the image that should be displayed exists (S25: YES), the remote side operation unit 101 generates image data and transmits the generated image data to the terminal apparatus 2a as the display information (S26). It should be noted that at this time, an image related to the generated image data is displayed on the virtual monitor.

After the transmission of the display information or in a case where the image that should be displayed does not exist in S25 (S25: NO), the remote side operation unit 101 determines whether or not the end notification of the remote operation is received from the terminal apparatus 2a (S27). In a case where the end notification is not received (S27: NO), the remote side operation unit 101 executes the processing of S23 and subsequent steps. In a case where the end notification is received (S27: YES), the remote side operation unit 101 cuts off the connection with the terminal apparatus 2a (S28), and the CPU 10 ends the present processing.

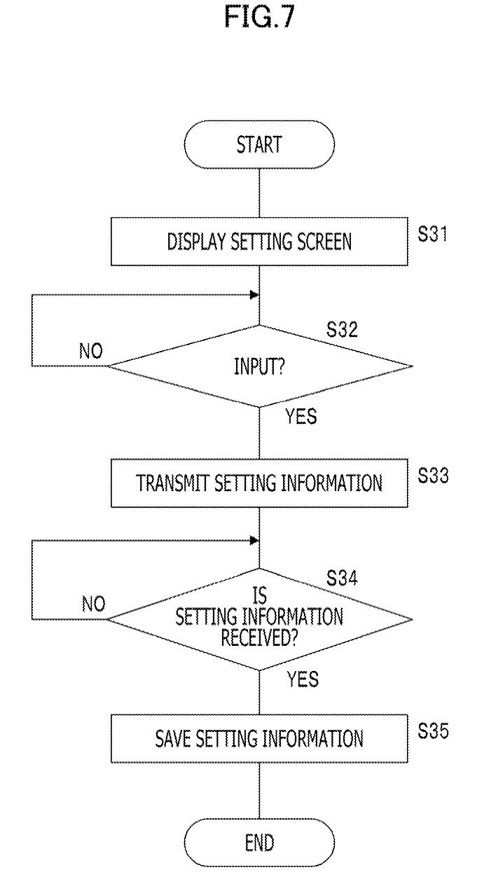

Next, a processing at the time of the setting for the setting information on the screen saver will be described. The setting information is input, for example, while following the setting screen displayed on the monitor 24c of the terminal apparatus 2a (see FIG. 4) and transmitted from the terminal apparatus 2a to the VM 1a of the remote machine 1. FIG. 7 is a flow chart showing a processing procedure executed by the terminal apparatus 2a at the time of the setting for the setting information.

The terminal side operation unit 201 displays the setting screen shown in FIG. 4 on the monitor 24c (S31) to determine whether or not the input is made while following the screen (S32). When no input is made to the window for the remote (S32: NO), the terminal side operation unit 201 stands by until an input is made to the window for the remote. In a case where an input is made to the window for the remote (S32: YES), the terminal side operation unit 201 transmits the input content the remote machine 1 as the setting information (S33).

After that, the SS setting information reception unit 202 determines whether or not the setting information is received from the VM 1a of the remote machine 1 (S34). In a case where the setting information is not received (S34: NO), the SS setting information reception unit 202 stands by until the setting information is received. In a case where the setting information is received (S34: YES), the SS setting information reception unit 202 saves the received setting information in the SS information saving unit 206 (S35), and the CPU 20 ends the present processing. It should be noted that the terminal apparatus 2a saves the setting information received from the remote machine 1, but the setting information input while following the setting screen may also be saved as it is.

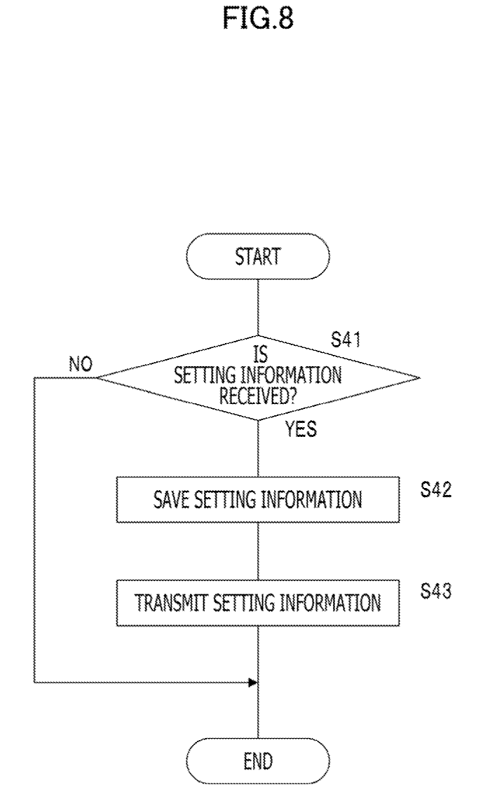

FIG. 8 is a flow chart showing a processing procedure executed by the VM 1a of the remote machine 1 at the time of the setting for the setting information.

The SS setting information acceptance unit 102 determines whether or not the setting information is received via the remote side operation unit 101 from the terminal apparatus 2a (S41). In a case where the setting information is not received (S41: NO), the CPU 10 ends the present processing. In a case where the setting information is received (S41: YES), the SS setting information acceptance unit 102 saves the setting information in the SS information saving unit 109 (S42) and transmits the setting information to the terminal apparatus 2a (S43). With this configuration, the same setting information is saved in the remote machine 1 and the terminal apparatus 2a. Then, the CPU 10 ends the present processing. It should be noted that the CPU 10 repeatedly executes the processing shown in FIG. 8.

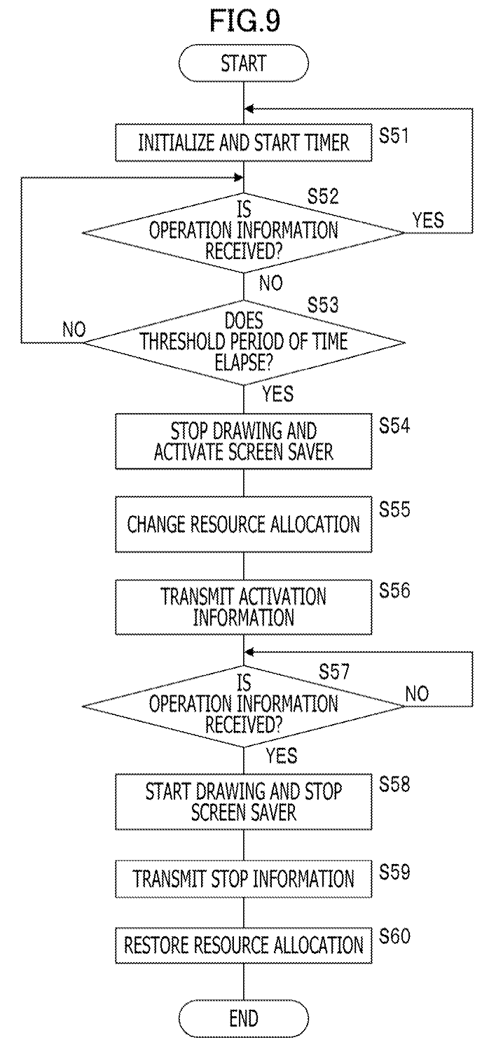

Next, a description will be given of a processing at the time of the activation and stoppage of the screen saver. FIG. 9 is a flow chart showing a processing procedure executed by the VM 1a of the remote machine 1 at the time of the activation or stoppage of the screen saver.

The determination unit 104 initializes (resets) and starts the timer (S51), the remote side operation unit 101 determines whether or not the operation information is received from the terminal apparatus 2a (S52). In a case where the operation information is received (S52: YES), the determination unit 104 repeatedly executes the processing in S51 until the remote side operation unit 101 does not receive the operation information. In a case where the operation information is not received (S52: NO), the determination unit 104 determines whether or not a threshold period of time elapses, i.e., an elapsing interval that equals or exceeds a threshold, after the operation information is not received (S53). In a case where the threshold period of time does not elapse yet (S53: NO), the determination unit 104 executes the processing in S52.

In a case where the threshold period of time elapses (S53: YES), the drawing stoppage SS control unit 107 stops the drawing of the image displayed by the terminal apparatus 2a to activate the screen saver in the VM 1a (S54). To be more specific, the drawing stoppage SS control unit 107 drives and controls the SS execution unit 108 to display the screen saver image in the blank state on the virtual monitor. As the screen saver image is the blank image, the processing load for generating the image in the VM 1a is alleviated.

Next, the resource release unit 106 requests the VMM 100 to change the resource allocation (S55). To be more specific, as described above, the resource release unit 106 requests the VMM 100 to change the weight value of the CPU 10 and sets the use time for the CPU 10 (as used by the VM 1a) to a smaller value. With this configuration, the unnecessary resource is released during the operation of the screen saver. After that, the SS control information transmission unit 105 transmits the activation information for activating the screen saver to the terminal apparatus 2a (S56).

The determination unit 104 determines whether or not the remote side operation unit 101 receives the operation information from the terminal apparatus 2a (S57). In a case where the remote side operation unit 101 does not receive the operation information (S57: NO), the determination unit 104 stands by until the operation information is received. In a case where the operation information is received (S57: YES), the determination unit 104 determines that the operation is input in the terminal apparatus 2a, starts the drawing of the image to be displayed, and stops the screen saver executed in the VM 1 (S58). That is, the drawn image is displayed on the virtual monitor.

The SS control information transmission unit 105 transmits the stoppage information for stopping the screen saver to the terminal apparatus 2a (S59). After that, the resource release unit 106 requests the VM 100 to restore the changed resource allocation to the original (S60). Then, the CPU 10 ends the present processing. In this manner, at the time of the activation of the screen saver, by stopping the drawing in the remote machine 1, it is possible to alleviate the processing load of the CPU 10. It should be noted that the CPU 10 repeatedly executes the processing shown in FIG. 9.

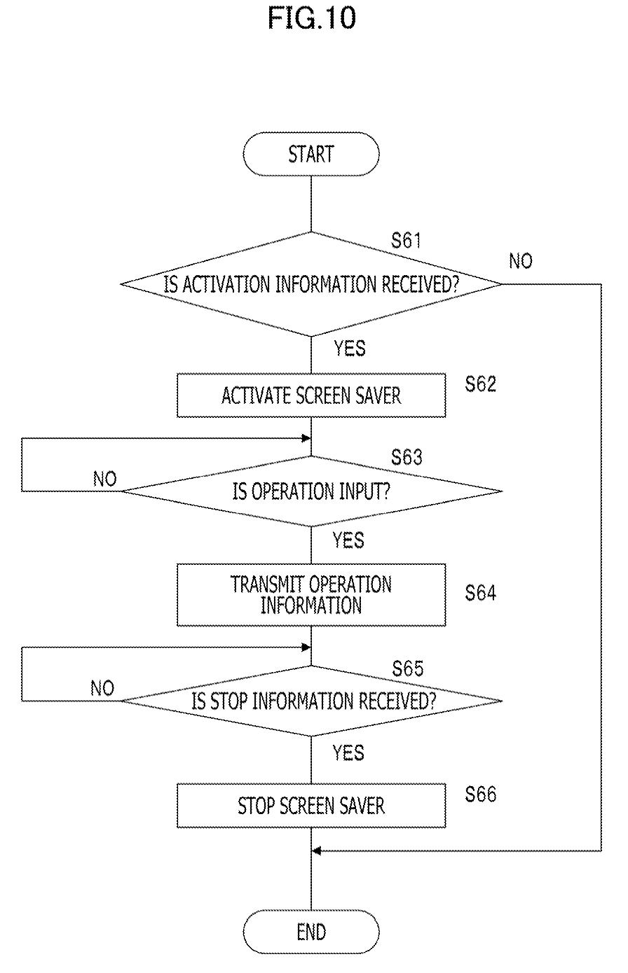

FIG. 10 is a flow chart showing a processing procedure executed by the terminal apparatus 2a at the time of the activation and stoppage of the screen saver.

The SS control information reception unit 203 determines whether or not the activation information is received from the VM 1a of the remote machine 1 (S61). In a case where the activation information is not received (S61: NO), the CPU 20 ends the present processing. In a case where the activation information is received (S61: YES), the SS control unit 204 activates the screen saver (S62). That is, the SS execution unit 205 displays the screen saver image on the monitor 24c on the basis of the setting information saved in the SS information saving unit 206.

Next, the terminal side operation unit 201 determines whether or not the operation is input to the window for the remote from the key board 24a or the mouse 24b (S63). in a case where the operation is not input (S63: NO), the terminal side operation unit 201 stands by until the operation is input. In a case where the operation is input (S63: YES), the terminal side operation unit 201 transmits the operation information to the VM 1a of the remote machine 1 (S64).

The SS control information reception unit 203 determines whether or not the stoppage information is received from the VM 1a of the remote machine 1 (S65). In a case where the stoppage information is not received (S65: NO), the SS control information reception unit 203 stands by until the stoppage information is received. In a case where the stoppage information is received (S65: YES), the SS control information reception unit 203 stops the activated screen saver (S66), and the CPU 20 ends the present processing. At a time point when the operation is input from the key board 24a or the mouse 24b, the screen saver may be stopped without waiting for the stoppage information reception from the VM 1a of the remote machine 1. It should be noted that the CPU 20 repeatedly executes the processing shown in FIG. 10.

As described above, according to the present first embodiment, the remote machine 1 and the terminal apparatuses 2a, 2b, and 2c save the setting information related to the screen saver in a synchronized manner. Then, whether or not the screen saver is activated in the terminal apparatuses 2a, 2b, and 2c is determined by the VM 1a of the remote machine 1. With this configuration, the activation of the screen saver can be synchronized in the VM la of the remote machine 1 and the terminal apparatuses 2a, 2b, and 2c. Then, in a case where the screen saver is activated, in the VM 1a of the remote machine 1, the image drawing is stopped and the screen saver whose screen is in the blank state is activated, so that the resource consumption in the VM 1a of the remote machine 1 can be partially, if not totally, suppressed. As a result, it is possible to effectively utilize the resource during the activation of the screen saver.

### Second Embodiment

Hereinafter, a description will be given of an information processing system according to a second embodiment. According to the first embodiment, the determination on the activation and stoppage of the screen saver is carried out in the VM 1a of the remote machine 1, but according to the present second embodiment, the determination is carried out in the terminal apparatuses 2a, 2b, and 2c. It should be noted that configurations which can be realized by configurations similar to the information processing system according to the above-mentioned first embodiment are assigned with the same reference symbols, and a description thereof will be omitted.

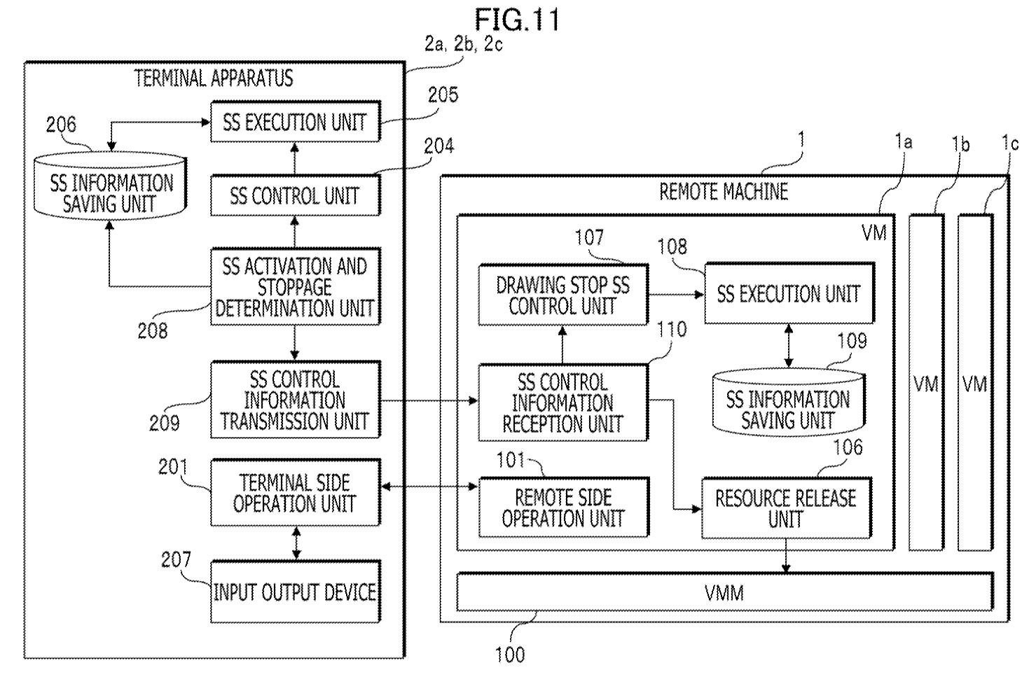

FIG. 11 is a function block diagram showing a function of the information processing system according to the present second embodiment.

The VM 1a operating in the remote machine 1 is provided with functions of the remote side operation unit 101, the resource release unit 106, the drawing stoppage SS control unit 107, the SS execution unit 108, the SS information saving unit 109, an SS control information reception unit 110, and the like. Also, the terminal apparatus 2a is provided with functions of the terminal side operation unit 201, the SS control unit 204, the SS execution unit 205, the SS information saving unit 206, an SS activation and stoppage determination unit 208 (hereafter “determination unit 208”), an SS control information transmission unit 209, and the like. It should be noted that in FIG. 11, the SS setting information acceptance unit 102, the SS setting information transmission unit 103, the terminal side operation unit 201, and the like described according to the first embodiment are not illustrated (for the purposes of simplifying the drawing), but the configuration is similar to the first embodiment.

The determination unit 208 has the same function as the determination unit 104 described according to the first embodiment. That is, the determination unit 208 determines activation or stoppage of the screen saver on the basis of the setting information saved in the SS information saving unit 206. For example, in a case where the terminal side operation unit 201 does not accept the operation from the input output device 207 for a certain period of time or longer, the determination unit 208 activates the screen saver. Also, in a case where the terminal side operation unit 201 accepts the operation, the determination unit 208 stops the screen saver. The determination unit 208 outputs the determination result to the SS control information transmission unit 209 and the SS control unit 204.

The SS control information transmission unit 209 transmits the control information the SS control information reception unit 110 in the remote machine 1 on the basis of the determination result output from the determination unit 208. The SS control information reception unit 110 in the remote machine 1 outputs the control information received from the SS control information transmission unit 209 to the resource release unit 106 and the drawing stoppage SS control unit 107. The resource release unit 106 requests the VMM 100 to change the resource allocation on the basis of the control information output from the SS control information reception unit 110. The drawing stoppage SS control unit 107 drives and controls the SS execution unit 108 while following the control information output from the SS control information reception unit 110.

Next, an operation of the information processing system according to the present second embodiment will be described on the basis of a flow chart. Hereinafter, only a processing at the time of the activation and stoppage of the screen saver that is different from the first embodiment will be described.

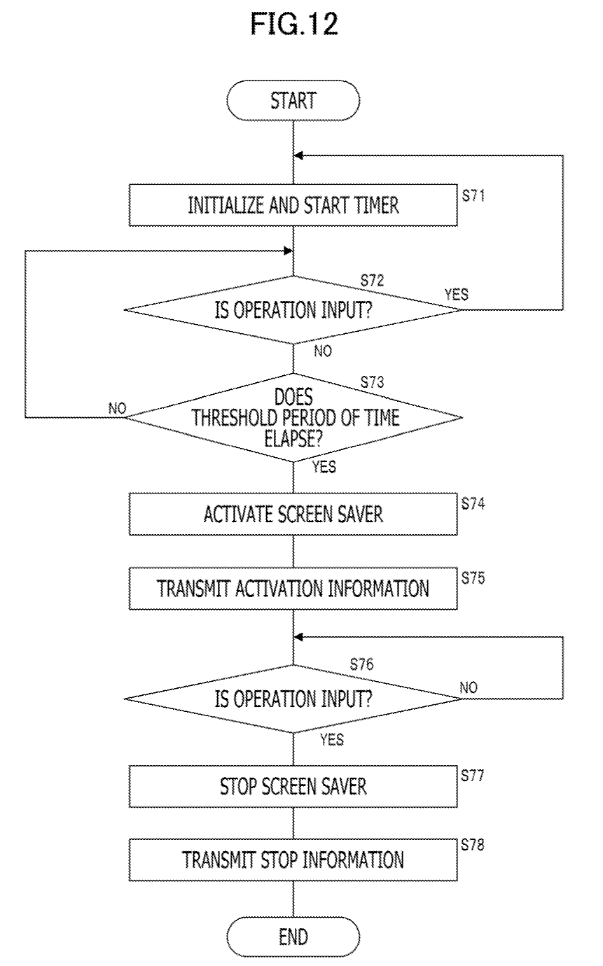

FIG. 12 is a flow chart showing a processing procedure executed by the terminal apparatus 2a at the time of the activation and stoppage of the screen saver.

The determination unit 208 initializes and starts the timer (S71), and the remote side operation unit 101 determines whether or not the operation is input from the input output device 207 (S72). In a case where the operation is input (S72: YES), the determination unit 208 repeatedly executes the processing in S71 until the operation is no longer input. In a case where the operation is not input (S72: NO), the determination unit 208 determines whether or not a threshold period of time elapses after the operation is no longer input (S73). In a case where the threshold period of time does not elapse yet (S73: NO), the determination unit 208 executes the processing in S72.

In a case where the threshold period of time elapses (S73: YES), the determination unit 208 activates the screen saver (S74). To be more specific, the SS control unit 204 drives and controls the SS execution unit 205 and displays the screen saver image on the monitor 24c on the basis of the setting information saved in the SS information saving unit 206. The SS control information transmission unit 209 transmits the activation information to the remote machine 1 (S75).

The determination unit 208 determines whether or not the operation is input to the remote side operation unit 101 from the input output device 207 (S76). In a case where the operation is not input (S76: NO), the determination unit 208 repeatedly executes the processing in S76 until the operation is input. In a case where the operation is input (S76: YES), the determination unit 208 stops the screen saver (S77). The SS control information transmission unit 209 transmits the stoppage information to the remote machine 1 (S78), and the CPU 20 ends the present processing. It should be noted that the CPU 20 repeatedly executes the processing shown in FIG. 12.

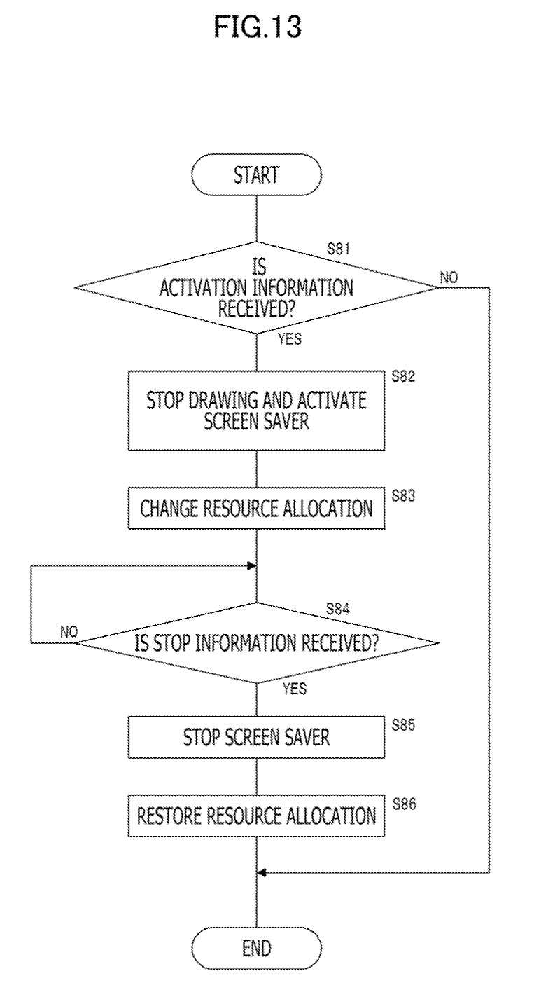

FIG. 13 is a flow chart showing a processing procedure executed by the remote machine 1 at the time of the activation and stoppage of the screen saver.

The SS control information reception unit 110 determines whether or not the activation information is received from the terminal apparatus 2a (S81). In a case where the activation information is not received (S81: NO), the CPU 10 ends the present processing. In a case where the activation information is received (S81: YES), the drawing stoppage SS control unit 107 stops the drawing of the image displayed by the terminal apparatus 2a to activate the screen saver in the VM 1a (S82). Then, the resource release unit 106 requests the VMM 100 to change the resource allocation (S83).

Next, the SS control information reception unit 110 determines whether or not the stoppage information is received from the terminal apparatus 2a (S84). In a case where the stoppage information is not received (S84: NO), the SS control information reception unit 110 stands by until the stoppage information is received. In a case where the stoppage information is received (S84: YES), the SS execution unit 108 stops the activated screen saver (S85). The resource release unit 106 requests the VM 100 to restore the changed resource allocation to the original (S86). Then, the CPU 10 ends the present processing. It should be noted that the CPU 10 repeatedly executes the processing shown in FIG. 13.

As described above, according to the present second embodiment, whether or not the screen saver is activated in the terminal apparatuses 2a, 2b, and 2c is determined by the terminal apparatuses 2a, 2b, and 2c, and the VM 1a of the remote machine 1 is notified of the activation. With this configuration, the activation of the screen saver can be synchronized in the VM 1a of the remote machine 1 and the terminal apparatuses 2a, 2b, and 2c. Then, in a case where the screen saver is activated, in the VM 1a of the remote machine 1, the image drawing is stopped and the screen saver whose screen is in the blank state is activated, so that the resource consumption in the VM 1a of the remote machine 1 can be partially, if not totally, suppressed. As a result, it is possible to effectively utilize the resource during the activation of the screen saver.

### Third Embodiment

Hereinafter, a description will be given of an information processing system according to a third embodiment. According to the first embodiment, the screen saver is activated in the remote machine 1 and the terminal apparatuses 2a, 2b, and 2c in a synchronism manner. In contrast to this, according to the present third embodiment, it is possible to set as to whether such synchronization is valid or invalid. Hereinafter, a difference point will be described.

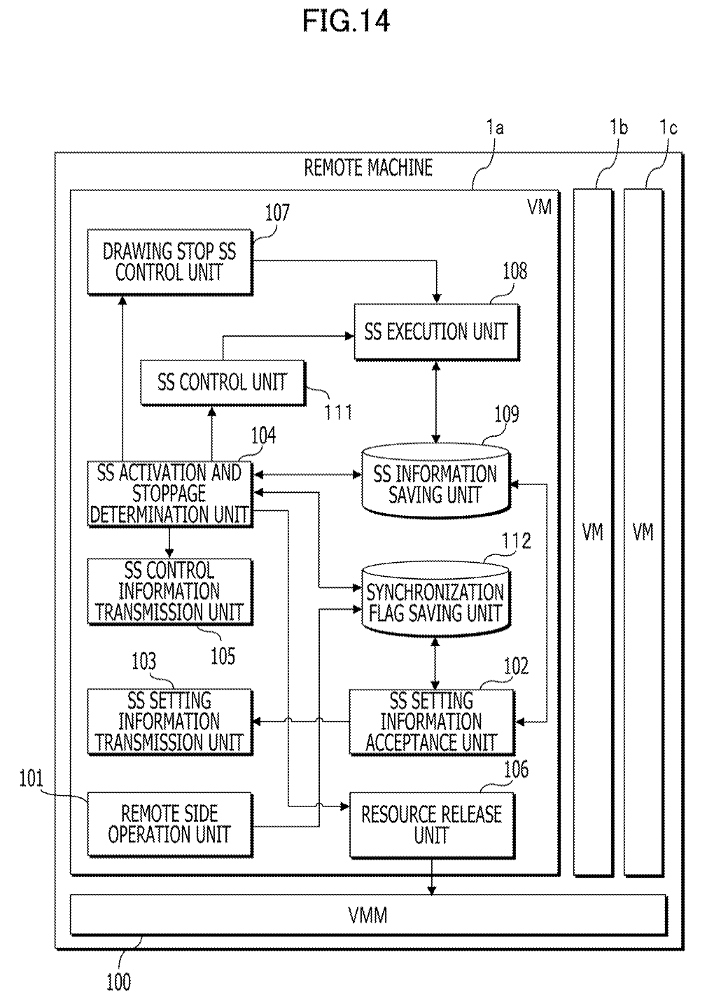

FIG. 14 is a function block diagram showing a function of the remote machine 1 related to the information processing system according to the present third embodiment. In FIG. 14, the functions of the terminal apparatuses 2a, 2b, and 2c are similar to those of FIG. 3 and are therefore omitted. The VM 1a operating in the remote machine 1 is further provided with functions of an SS control unit 111, a synchronization flag saving unit 112, and the like in addition to the functions described with reference to FIG. 3.

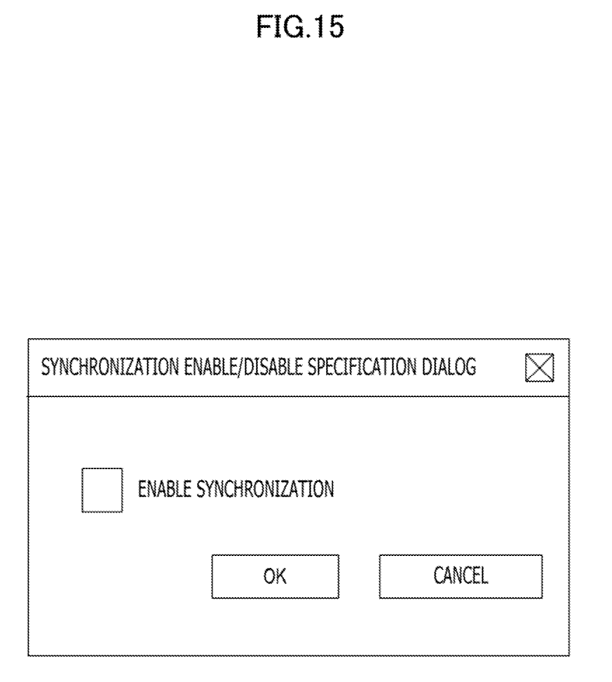

The remote side operation unit 101 carries out the transmission and reception of the operation information and the display information with the terminal apparatus 2a similarly as in the first embodiment. Furthermore, the remote side operation unit 101 receives a synchronization flag from the terminal apparatus 2a and saves the synchronization flag in the synchronization flag saving unit 112. The synchronization flag is a flag for determining whether the synchronization of the activation for the screen saver in the terminal apparatus 2a and the VM 1a of the remote machine 1 is set enablel or disablel. The synchronization flag is set, for example, while following a setting screen displayed on the monitor 24c of the terminal apparatus 2a. FIG. 15 shows an example of the setting screen displayed on the monitor 24c of the terminal apparatus 2a. In the setting screen of FIG. 15, a check box is displayed in which the box is ticked in a case where the synchronization is set valid. In a case where the check box is ticked and an OK button is selected, the synchronization is set valid. On the other hand, in a case where the check box is not ticked and the OK button is selected, the synchronization is set invalid.

The SS setting information acceptance unit 102 accepts the setting information related to the screen saver via the remote side operation unit 101 to be saved in the SS information saving unit 109. Also, in a case where the SS setting information acceptance unit 102 determines that the synchronization is valid on the basis of the synchronization flag saved in the synchronization flag saving unit 112, the setting information is output to the SS setting information transmission unit 103. The SS setting information transmission unit 103 transmits the setting information output from the SS setting information acceptance unit 102 to the terminal apparatus 2a.

The determination unit 104 determines whether the screen saver is activated or stopped. The determination unit 104 switches output destinations for the determination result in accordance with the synchronization flag saved in the synchronization flag saving unit 112. In a case where the synchronization is valid, the determination unit 104 outputs the determination result to the SS control information transmission unit 105, the resource release unit 106, and the drawing stoppage SS control unit 107. On the other hand, in a case where the synchronization is invalid, the determination unit 104 outputs the determination result only to the SS control unit 111.

That is, in a case where the synchronization is valid, the drawing stoppage SS control unit 107 stops the drawing, the screen saver in the blank state is activated or stopped, and the resource release unit 106 releases the resources. Also, the SS control information transmission unit 105 notifies the terminal apparatus 2a of the activation, and the terminal apparatus 2a activates the screen saver. On the other hand, in a case where the synchronization is invalid, the SS control unit 111 activates or stops the screen saver which follows the setting information saved in the SS information saving unit 109, and the terminal apparatus 2a is not notified of the activation. That is, the terminal apparatus 2a does not activate the screen saver. In the terminal apparatus 2a, it is possible to perform an operation of an application independently executed other than the operation in the VM 1a. Accordingly, a case may exist in which when the operation with respect to the VM 1a is not input, another operation is carried out. Thus, it is possible to reduce instances of, if not prevent, the screen saver from activating during the operation while the synchronization is not established with the remote machine 1. Also, even in a case where the synchronization is invalid, at the activation of the screen saver, the resource release unit 106 may release the resources. Normally, during the activation of the screen saver, a problem does not occur even when not many usable resources exist. By releasing the resources, during the activation of the screen saver, the other VMs can utilize the resources, and it is therefore possible to efficiently utilize the resources.

Next, an operation of the information processing system according to the present third embodiment will be described on the basis of a flow chart.

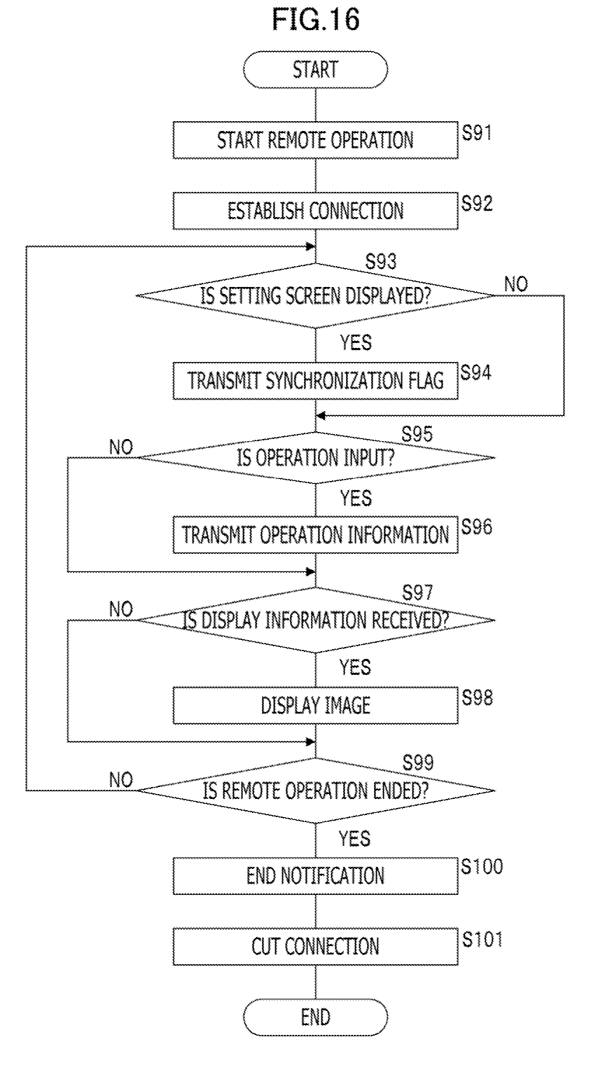

First, a processing at the time of the start and stop of the remote operation will be described. FIG. 16 is a flow chart showing a processing procedure executed by the terminal apparatus 2a at the time of the start and stop of the remote operation.

The CPU 20 starts the remote operation (S91). The CPU 20 starting the remote operation gains the respective functions described with reference to FIG. 3 and executes the following processing. The terminal side operation unit 201 establishes a communication connection with the remote machine 1 (S92). After the connection with the VM 1a of the remote machine 1 is established, the terminal side operation unit 201 determines whether or not a setting screen shown in FIG. 15, for example, is displayed on the basis of the operation by the user (S93). In a case where the setting screen is displayed (S93: YES), the terminal side operation unit 201 displays the setting screen shown in FIG. 15 and transmits the synchronization flag input while following the screen to the VM 1a of the remote machine 1 (S94).

After the transmission of the synchronization flag or in a case where the setting screen is not displayed in S93 (S93: NO), the terminal side operation unit 201 determines whether or not the user operation is input to the window for the remote from the key board 24a or the mouse 24b (S95). In a case where the operation is input (S95: YES), the terminal side operation unit 201 transmits the operation information to the VM 1a of the remote machine 1 (S96). After the transmission of the operation information or in a case where the operation is not input in S95 (S95: NO), the terminal side operation unit 201 determines whether or not the display information is received from the VM 1a of the remote machine 1 (S97).

In a case where the display information is received (S97: YES), the terminal side operation unit 201 displays the image on the monitor 24c on the basis of the display information (S98). After the image is displayed or in a case where the display information is not received in S97 (S97: NO), the terminal side operation unit 201 determines whether or not the remote operation is ended (S99).

In a case where the remote operation is not ended (S99: NO), the terminal side operation unit 201 executes the processing of S93 and subsequent steps. In a case where the remote operation is ended (S99: YES), the terminal side operation unit 201 notifies the remote machine 1 of the end of the remote operation (S100). Then, the terminal side operation unit 201 cuts off the connection with the remote machine 1 (S101), and the CPU 20 ends the present processing.

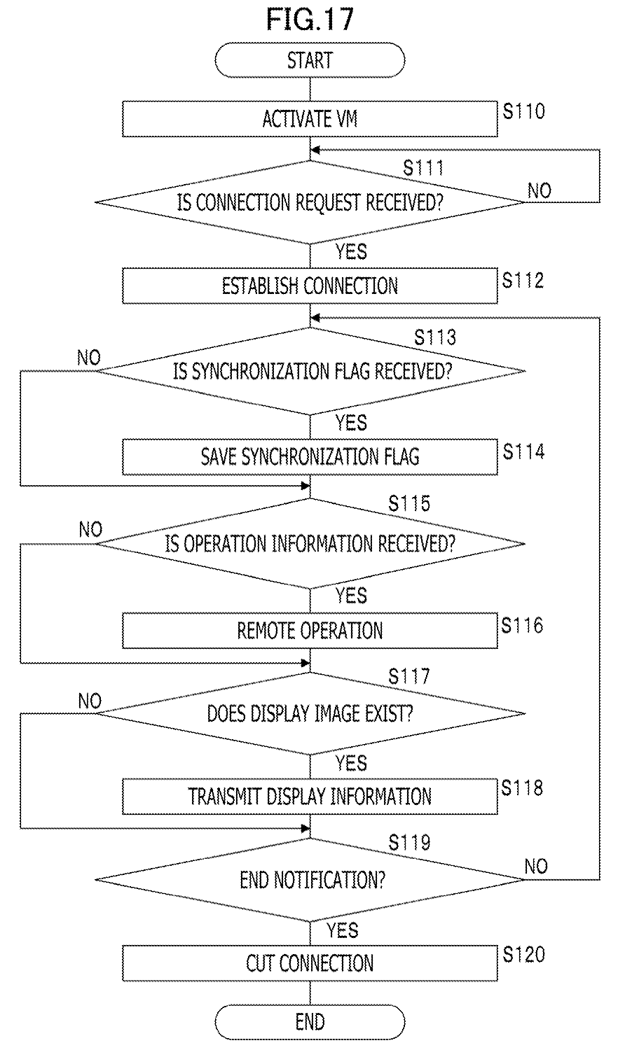

FIG. 17 is a flow chart showing a processing procedure executed by the remote machine 1 at the time of the start and stop of the remote operation.

After the power source for the remote machine 1 is turned ON and the activation of the hardware respective units in the remote machine 1 is completed, the CPU 10 sequentially executes the VMM program and the management OS program to activate the VMs 1a, 1b, and 1c (S110). Also, the VMs 1a, 1b, and 1c may be activated in accordance with a request from the terminal apparatus. After the activation, as the CPU 10 executes the guest OS program, the OS is operated on the VM 1a. Then, the VM 1a gains the respective functions described with reference to FIG. 14 and executes the following processing.

The remote side operation unit 101 determines whether or not the connection request from the terminal apparatus 2a is received (S111). In a case where the connection request is not received (5111: NO), the remote side operation unit 101 stands by until the connection request is received. In a case where the connection request is received (5111: YES), the remote side operation unit 101 establishes the connection with the terminal apparatus 2a which requests the communication connection (S112). The remote side operation unit 101 determines whether or not the synchronization flag is received from the terminal apparatus 2a (S113). In a case where the synchronization flag is received (S113: YES), the remote side operation unit 101 saves the synchronization flag in the synchronization flag saving unit 112 (S114). After the saving or in a case where the synchronization flag is not received (S113: NO), the remote side operation unit 101 determines whether or not the operation information is received from the terminal apparatus 2a (S115). In a case where the operation information is received (S115: YES), the remote side operation unit 101 executes the remote operation by executing the processing based on the operation information (S116).

After the execution of the remote operation or in a case where the operation information is not received in S115 (S115: NO), the remote side operation unit 101 determines whether or not the image that should be displayed exists (S117). In a case where the image that should be displayed exists (S117: YES), the remote side operation unit 101 transmits the display information to the terminal apparatus 2a (S118). After the transmission of the display information or in a case where the image that should be displayed does not exist in S117 (S117: NO), the remote side operation unit 101 determines whether or not the end notification of the remote operation is received from the terminal apparatus 2a (S119). In a case where the end notification of the remote operation is not received (S119: NO), the remote side operation unit 101 executes the processing in S113 and subsequent steps. In a case where the end notification of the remote operation is received (S119: YES), the remote side operation unit 101 cuts off the connection with the terminal apparatus 2a (S120), and the CPU 10 ends the present processing.

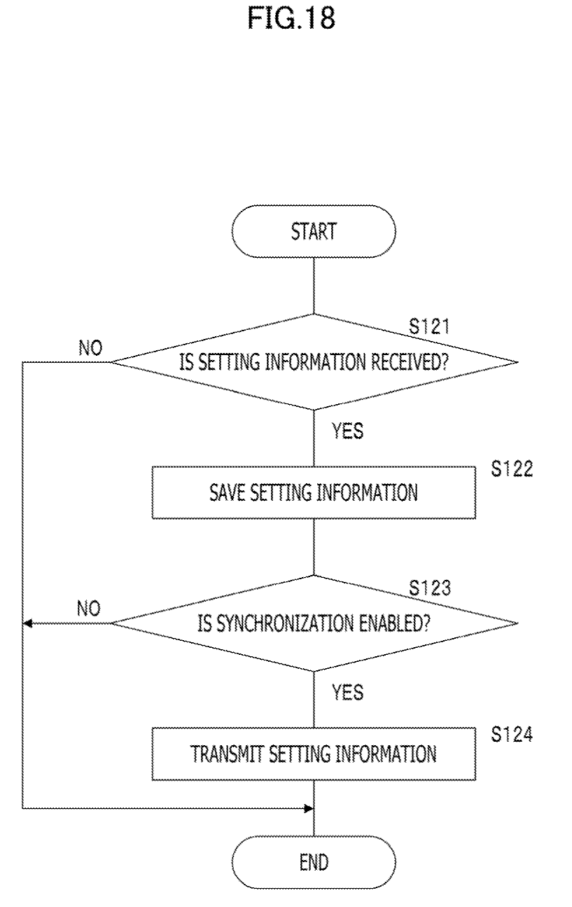

Next, a processing at the time of the setting for the setting information on the screen saver will be described. FIG. 18 is a flow chart showing a processing procedure executed by the VM 1a of the remote machine 1 at the time of the setting for the setting information. It should be noted that the processing procedure executed by the terminal apparatuses 2a, 2b, and 2c is similar to that of FIG. 7 and is therefore omitted.

The SS setting information acceptance unit 102 determines whether or not the setting information is received via the remote side operation unit 101 from the terminal apparatus 2a (S121). In a case where the setting information is not received (S121: NO), the CPU 10 ends the present processing. In a case where the setting information is received (S121: YES), the SS setting information acceptance unit 102 saves the setting information in the SS information saving unit 109 (S122). The SS setting information acceptance unit 102 determines whether or the synchronization with the terminal apparatus 2a is valid on the basis of the synchronization flag saved in the synchronization flag saving unit 112 (S123). In a case where the synchronization is not valid (S123: NO), it is not necessary to synchronize with the terminal apparatus 2a, and the CPU 10 ends the present processing without transmitting the setting information to the terminal apparatus 2a. In a case where the synchronization is valid (S123: YES), the SS setting information transmission unit 103 transmits the setting information to the terminal apparatus 2a (S124). Then, the CPU 10 ends the present processing. It should be noted that the CPU 10 repeatedly executes the processing shown in FIG. 18.

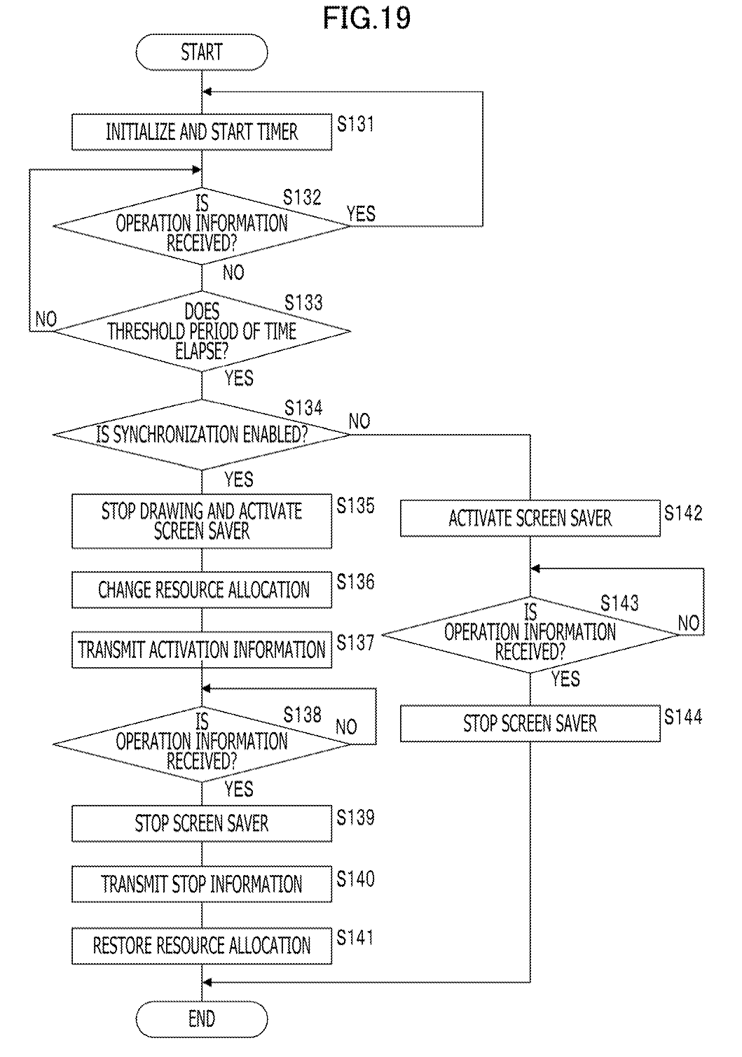

Next, a processing at the time of the activation and stoppage of the screen saver will be described. FIG. 19 is a flow chart showing a processing procedure executed by the VM 1a of the remote machine 1 at the time of the activation and stoppage of the screen saver. It should be noted that the processing procedure executed by the terminal apparatus 2a is similar to that of FIG. 10 and is therefore omitted.

The determination unit 104 initializes and starts the timer (S131), the remote side operation unit 101 determines whether or not the operation information is received from the terminal apparatus 2a (S132). In a case where the operation information is received (S132: YES), the determination unit 104 repeatedly executes the processing in S131 until the operation information is no longer received. In a case where the operation information is not received (S132: NO), the determination unit 104 determines whether or not a threshold period of time elapses after the operation information is not received (S133). In a case where the threshold period of time does not elapse yet (S133: NO), the determination unit 104 executes the processing in S132.

In a case where the threshold period of time elapses (S133: YES), the determination unit 104 determines whether or not the synchronization with the terminal apparatus 2a is valid on the basis of the synchronization flag saved in the synchronization flag saving unit 112 (S134). In a case where the synchronization is valid (S134: YES), the drawing stoppage SS control unit 107 stops the drawing of the image displayed by the terminal apparatus 2a, and the screen saver in the blank state is activated in the VM 1a (S135).

Next, the resource release unit 106 requests the VMM 100 to change the resource allocation (S136). After that, the SS control information transmission unit 105 transmits the activation information to the terminal apparatus 2a (S137). The determination unit 104 determines whether or not the remote side operation unit 101 receives the operation information from the terminal apparatus 2a (S138). In a case where the remote side operation unit 101 does not receive the operation information (S138: NO), the determination unit 104 stands by until the operation information is received. In a case where the operation information is received (S138: YES), the determination unit 104 determines that the operation is input in the terminal apparatus 2a and stops the screen saver executed by the VM 1a (S139).

The SS control information transmission unit 105 transmits the stoppage information to the terminal apparatus 2a (S140), and the resource release unit 106 requests the VM 100 to restore the changed resource allocation to the original (S141). Then, the CPU 10 ends the present processing.

On the other hand, in S134, in a case where the synchronization is not invalid (S134: NO), the SS control unit 111 drives and controls the SS execution unit 108, and on the basis of the setting information saved in the SS information saving unit 109, the screen saver is activated (S142). The determination unit 104 determines whether or not the remote side operation unit 101 receives the operation information from the terminal apparatus 2a (S143). In a case where the remote side operation unit 101 does not receive the operation information (S143: NO), the determination unit 104 stands by until the operation information is received. In a case where the operation information is received (S143: YES), the determination unit 104 determines that the operation is input in the terminal apparatus 2a and stops the screen saver (S144). Then, the CPU 10 ends the present processing. It should be noted that the CPU 10 repeatedly executes the processing shown in FIG. 19.

As described above, according to the present third embodiment, it is possible to set as to whether or not the activation of the screen saver is synchronized in the VM 1a of the remote machine 1 and the terminal apparatuses 2a, 2b, and 2c. In a case where the synchronization is not carried out, even in a case where the VM 1a of the remote machine 1 activates the screen saver without receiving the operation information from the terminal apparatuses 2a, 2b, and 2c for a certain period of time, the screen saver is not activated in the terminal apparatuses 2a, 2b, and 2c. In the terminal apparatuses 2a, 2b, and 2c, in addition to the operations of the VMs 1a, 1b, and 1c, it is possible to operate an application independently executed. Accordingly, a case may exist in which when the operations with respect to the VMs 1a, 1b, and 1c are not input, another operation is carried out. Thus, it is possible to prevent the screen saver from activating during the operation while the synchronization is not established with the VM 1a of the remote machine 1.

### Fourth Embodiment

Hereinafter, a description will be given of an information processing system according to a fourth embodiment. According to the present fourth embodiment, the setting in which the synchronization is valid or invalid which is described according to the third embodiment is carried out in accordance with whether or not the applications are executed in the terminal apparatuses 2a, 2b, and 2c. Hereinafter, a description will be given of a different point from the third embodiment.

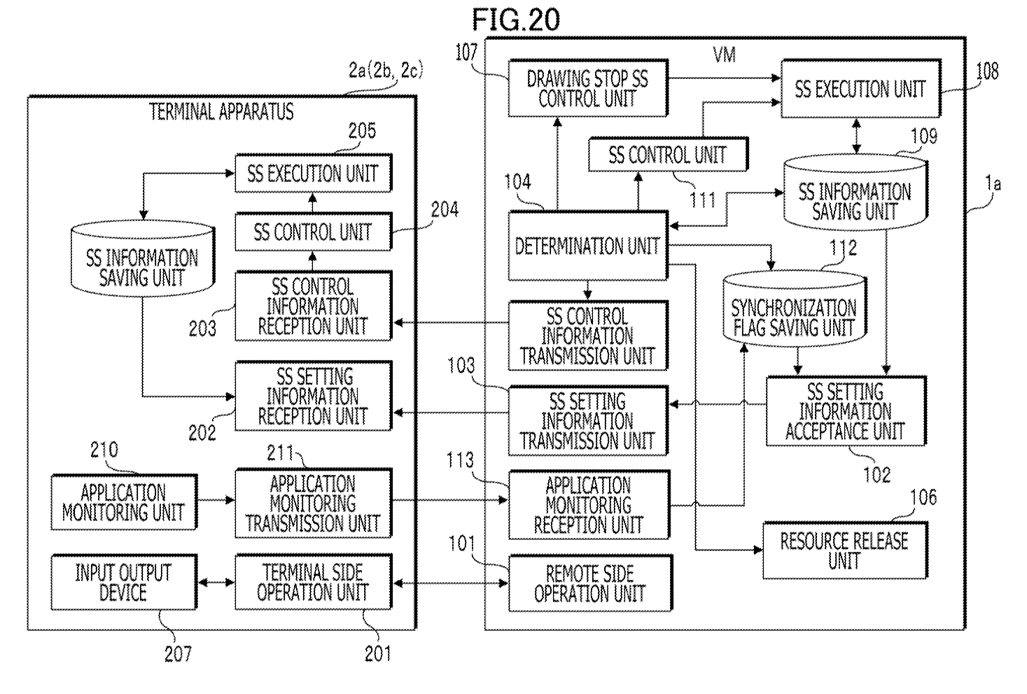

FIG. 20 is a function block diagram showing a function of the information processing system according to the present fourth embodiment. In FIG. 20, only the function of the VM 1a of the remote machine 1 is illustrated (for the purposes of simplifying the drawing), and the other VMs 1b and 1c and the VMM 100 are omitted.

The VM 1a operating in the remote machine 1 is further provided with a function of an application monitoring reception unit 113 in addition to the function described according to the third embodiment. The terminal apparatus 2a is further provided with functions of an application monitoring unit 210, an application monitoring transmission unit 211, and the like in addition to the functions described according to the first embodiment.

The application monitoring unit 210 of the terminal apparatus 2a obtains application information for every certain period of time. The application information is information for grasping whether or not the terminal apparatus 2a executes an application which is not related to the VM 1a. On the basis of the application information obtained by the application monitoring unit 210, the application monitoring transmission unit 211 transmits the synchronization flag to the remote machine 1. To be more specific, in a case where it is determined that the application is activated, the application monitoring transmission unit 211 transmits the synchronization flag indicating that the synchronization is invalid. On the other hand, in a case where it is determined that the application is not activated, the application monitoring transmission unit 211 transmits the synchronization flag indicating that the synchronization is valid. The application monitoring reception unit 113 saves the synchronization flag transmitted from the terminal apparatus 2a in the synchronization flag saving unit 112.

It should be noted that as the application executed by the terminal apparatus 2a which is not related to the VM 1a, for example, video reproduction software or the like exists. In the case of the video reproduction software, in the terminal apparatuses 2a, 2b, and 2c where video is reproduced, a probability in which the key board 24a and the mouse 24b is operated is low. For this reason, as the operation information is not received from the terminal apparatuses 2a, 2b, and 2c, the remote machine 1 may cause the terminal apparatuses 2a, 2b, and 2c to activate the screen saver in some cases. For this reason, in a case where the terminal apparatus 2a executes the video reproduction software, by setting the synchronization invalid, it is possible to prevent the screen saver from activating in the terminal apparatuses 2a, 2b, and 2c during the video reproduction.

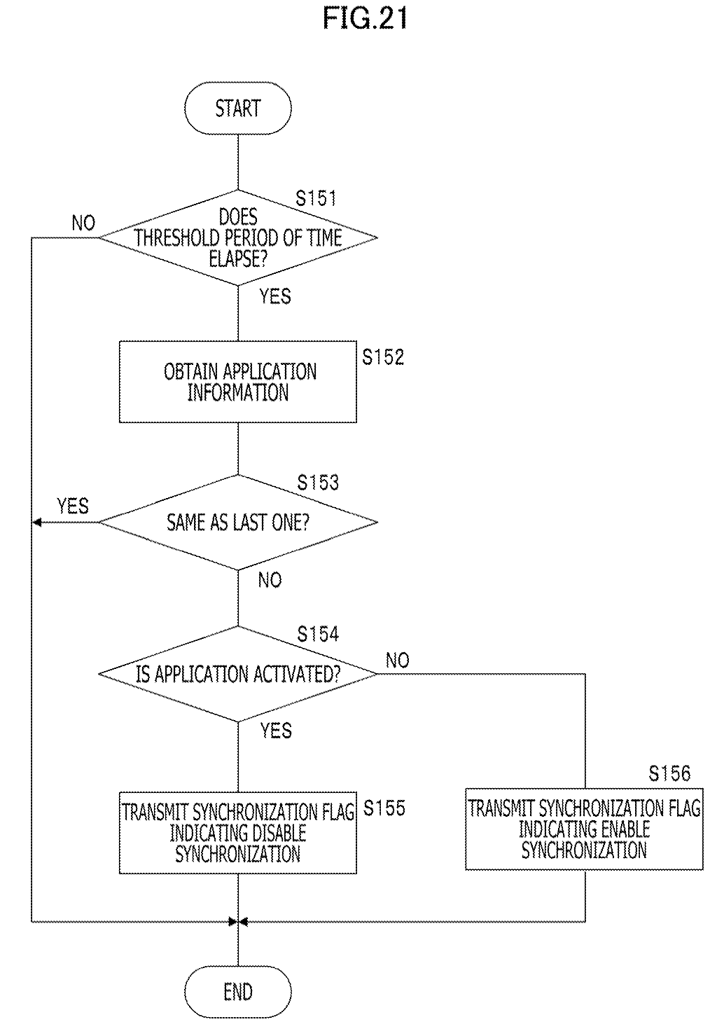

Next, an operation of the information processing system according to the present fourth embodiment will be described on the basis of a flow chart. FIG. 21 is a flow chart showing a processing procedure executed by the terminal apparatus 2a during application monitoring.

The CPU 20 determines whether or not a threshold period of time (for example, 5 seconds) elapses after the application monitoring unit 210 obtains the previous application information (S151). In a case where the threshold period of time does not elapse yet (S151: NO), the CPU 20 ends the present processing. In a case where the threshold period of time elapses (S151: YES), the application monitoring unit 210 obtains the application information (S152). The obtained application information is appropriately saved in the RAM 22 or the like. Next, the application monitoring unit 210 determines whether or not the application information obtained in S152 is the same as the information obtained last time (S153).

In a case where the application information is the same (S153: YES), it is determined that the activation state of the application is not changed, and the CPU 20 ends the present processing. In a case where the application information is not the same (S153: NO), the application monitoring unit 210 determines whether or not the application has been activated on the basis of the obtained application information (S154). In a case where the application is has been activated (S154: YES), the application monitoring transmission unit 211 transmits the synchronization flag indicating that the synchronization is disable to the VM 1a of the remote machine 1 (S155). In a case where the application not been activated (S154: NO), the application monitoring transmission unit 211 transmits the synchronization flag indicating that the synchronization is enable (S156). After the transmission of the synchronization flag, the CPU 20 ends the present processing. It should be noted that the CPU 20 repeatedly executes the processing shown in FIG. 21.

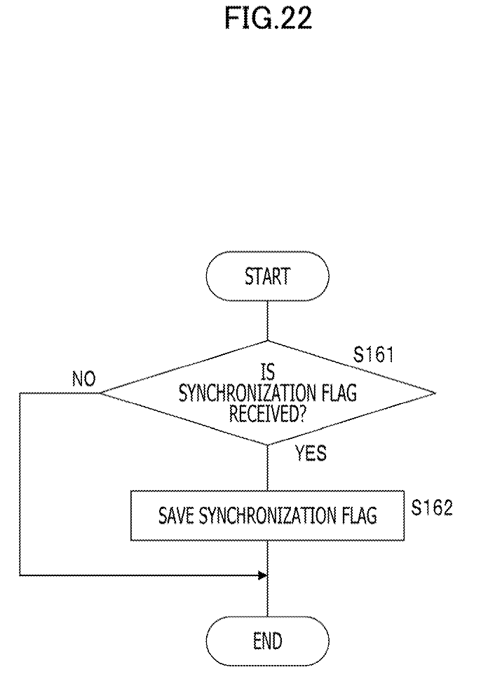

FIG. 22 is a flow chart showing a processing procedure executed by the VM 1a of the remote machine 1 during the application monitoring.

The application monitoring reception unit 113 determines whether or not the synchronization flag is received from the terminal apparatus 2a (S161). In a case where the synchronization flag is not received (S161: NO), the CPU 10 ends the present processing. In a case where the synchronization flag is received (S161: YES), the application monitoring reception unit 113 saves the synchronization flag in the synchronization flag saving unit 112 (S162). Then, the CPU 10 ends the present processing. It should be noted that the CPU 10 repeatedly executes the processing shown in FIG. 22.

As described above, according to the present fourth embodiment, the determination as to whether or not the synchronization is established between the VM 1a of the remote machine 1 and the terminal apparatuses 2a, 2b, and 2c is carried out in accordance with the activation states in the terminal apparatuses 2a, 2b, and 2c. With this configuration, for example, in a case where the terminal apparatus 2a executes the video production software, by setting the synchronization invalid, it is possible to reduce the number of instances of, if not prevent, the screen saver from activating in the terminal apparatuses 2a, 2b, and 2c during the video reproduction.

### Fifth Embodiment

Hereinafter, a description will be given of an information processing system according to a fifth embodiment. According to the present fifth embodiment, the terminal apparatuses 2a, 2b, and 2c are provided with a plurality of monitors.

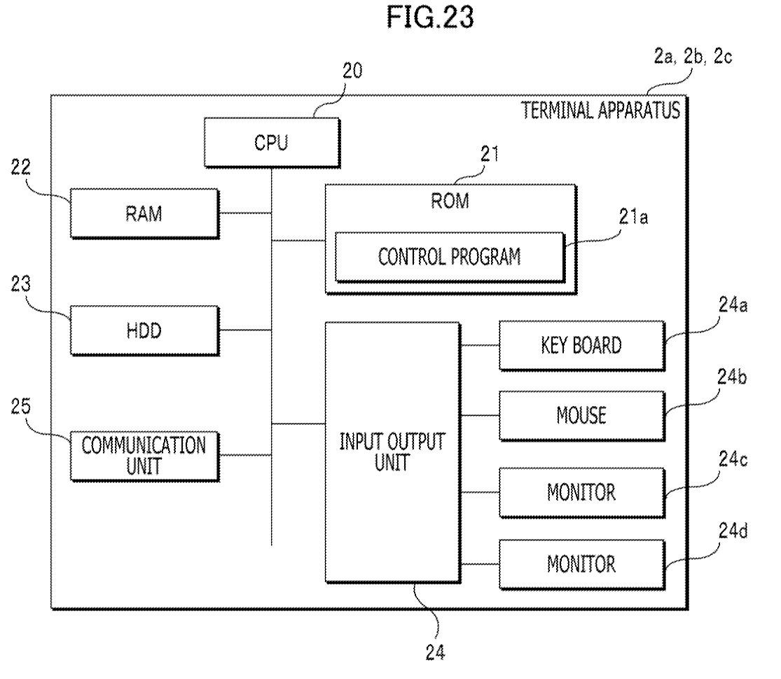

FIG. 23 is a block diagram showing configurations of the terminal apparatuses 2a, 2b, and 2c of the information processing system according to the fifth embodiment. As shown in FIG. 23, the terminal apparatuses 2a, 2b, and 2c are further provided with a monitor 24d in addition to the configuration described according to the first embodiment. The terminal apparatuses 2a, 2b, and 2c display basic operation screens executed by themselves on both the monitors 24c and 24d. Then, the terminal apparatuses 2a, 2b, and 2c display the window for the remote on any one of the monitors 24c and 24d and display the processing results of the VMs 1a, 1b, and 1c and the like in the window for the remote. Then, according to the present fifth embodiment, in a case where the screen saver is activated, the terminal apparatuses 2a, 2b, and 2c execute the screen saver with respect to the monitor on which the window for the remote is displayed.

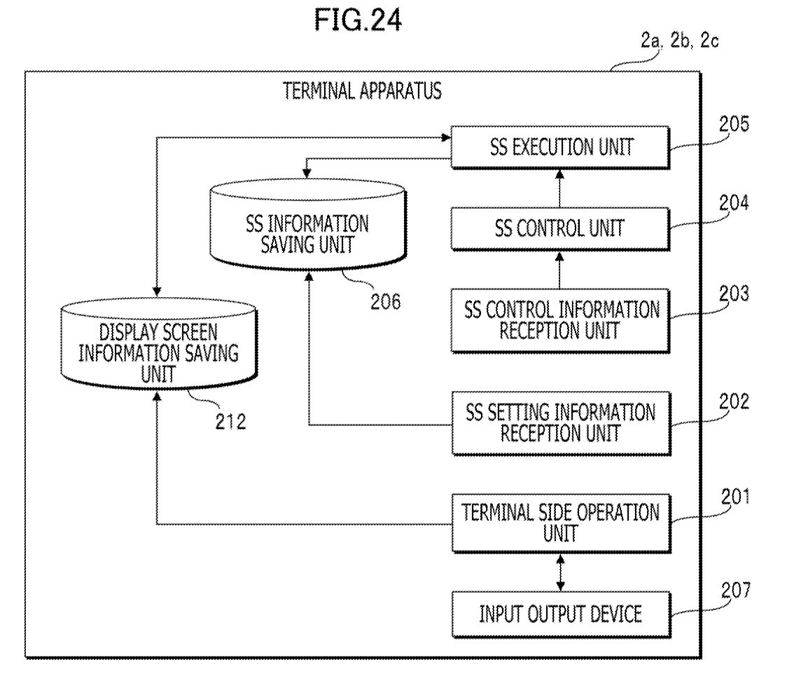

FIG. 24 is a function block diagram showing a function of the terminal apparatuses 2a, 2b, and 2c of the information processing system according to the fifth embodiment. It should be noted that the function of the remote machine 1 is similar to the first embodiment and is therefore omitted.

The terminal apparatuses 2a, 2b, and 2c are further provided with a function of a display screen information saving unit 212 in addition to the functions described according to the first embodiment. The terminal side operation unit 201 identifies the monitor on which the window for the remote is displayed among the monitors 24c and 24d and saves target screen information in the display screen information saving unit 212. The target screen information is information for identifying the monitor on which the window for the remote is displayed. The SS execution unit 205 executes the screen saver with respect to the monitor on which the window for the remote is displayed on the basis of the target screen information saved in the display screen information saving unit 212.

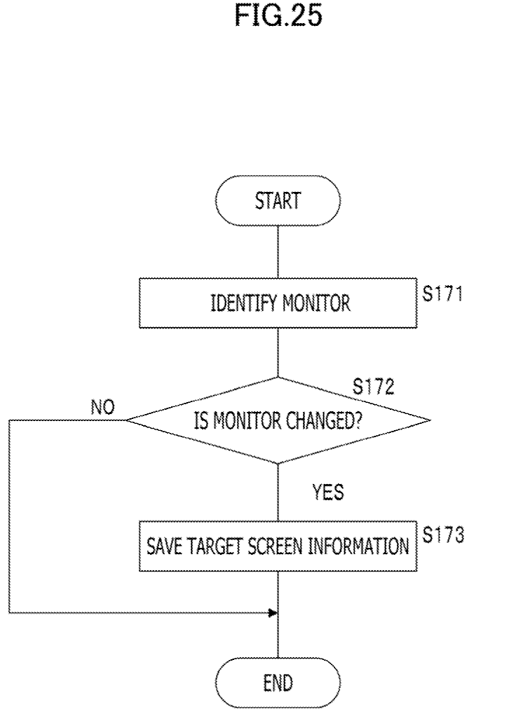

Next, an operation of the information processing system according to the present fifth embodiment will be described on the basis of a flow chart. FIG. 25 is a flow chart showing a processing procedure executed by the terminal apparatus 2a when the monitor displaying the window for the remote is identified.

The terminal side operation unit 201 identifies the monitor on which the window for the remote is displayed (S171). The terminal side operation unit 201 determines whether or not the monitor is changed from the previously identified monitor (S172). In a case where the monitor is changed (S172: YES), the terminal side operation unit 201 newly saves the target screen information in the display screen information saving unit 212 (S173). Then, the CPU 20 ends the present processing. On the other hand, in a case where the monitor is not changed (S172: NO), it is not necessary to save the target screen information, and therefore the CPU 20 ends the present processing. It should be noted that the CPU 20 repeatedly executes the processing shown in FIG. 25.

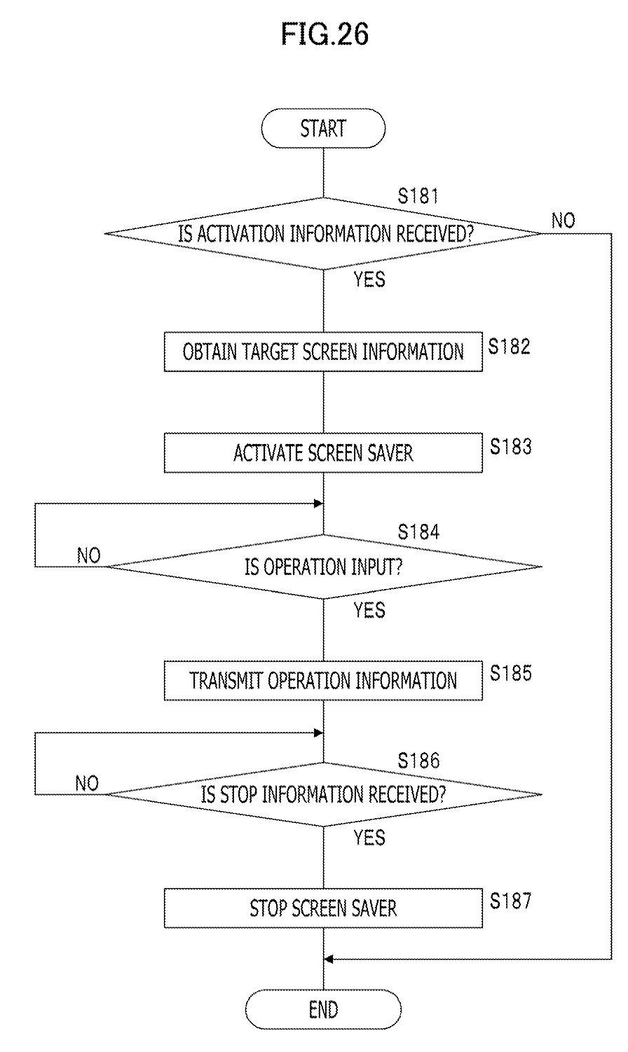

FIG. 26 is a flow chart showing a processing procedure executed by the terminal apparatus 2a at the time of the activation and stoppage of the screen saver.

The SS control information reception unit 203 determines whether or not the activation information is received from the VM 1a of the remote machine 1 (S181). In a case where the activation information is not received (S181: NO), the CPU 20 ends the present processing. In a case where the activation information is received (S181: YES), the SS execution unit 205 obtains the target screen information from the display screen information saving unit 212 and identifies the monitors 24c and 24d on which the window for the remote is displayed (S182).

The SS control unit 204 drives and controls the SS execution unit 205 to activate the screen saver with respect to the monitor 24c (or 24d) identified by the SS execution unit 205 (S183). That is, the SS execution unit 205 displays the screen saver image on the monitor 24c (or 24d) on the basis of the setting information saved in the SS information saving unit 206.

Next, the terminal side operation unit 201 determines whether or not the operation is input to the window for the remote from the key board 24a or the mouse 24b (S184). in a case where the operation is not input (S184: NO), the terminal side operation unit 201 stands by until the operation is input. In a case where the operation is input (S184: YES), the terminal side operation unit 201 transmits the operation information to the VM 1a of the remote machine 1 (S185).

The SS control information reception unit 203 determines whether or not the stoppage information is received from the VM 1a of the remote machine 1 (S186). In a case where the stoppage information is not received (S186: NO), the SS control information reception unit 203 stands by until the stoppage information is received. In a case where the stoppage information is received (S186: YES), the SS control information reception unit 203 stops the activated screen saver (S187), and the CPU 20 ends the present processing. It should be noted that the CPU 20 repeatedly executes the processing shown in FIG. 26.

As described above, according to the present fifth embodiment, the terminal apparatuses 2a, 2b, and 2c provided with the two monitors 24c and 24d execute the screen saver with respect to the monitor 24c (or 24d) on which the window for the remote is displayed. With this configuration, it is possible to reduce instances of, if not prevent, the execution of the screen saver in a case where an operation which is not related to the VMs 1a, 1b, and 1c is performed in one monitor 24d (or 24c). In this example, the case of using the two monitors has been described, but still more monitors may also be connected. Also, the window for the remote may be displayed on a plurality of screen among the plurality of monitors.

In the above, the example embodiments of the present invention have been specifically described, but the respective configurations, operations, and the like can appropriately be changed and are not limited to the above-mentioned embodiments. For example, according to the above-mentioned embodiments, the case has been described in which the screen saver image is displayed on the entire screen of the monitor, but the screen saver image may be displayed only on the window for the remote. In this case, even in a case where the VMs 1a, 1b, and 1c are not operated and the screen saver is activated, other processing operations can be performed.

Also, according to the above-mentioned embodiments, the remote machine 1 is not provided with input output unit such as a key board, a mouse, or a monitor but may be provided with the input output unit. Then, from input output unit, an input following the setting screen of FIG. 4 or FIG. 15 may be carried out. According to the above-mentioned embodiments, the case has been described in which the plurality of VMs are operated in the remote machine 1, but according to the present invention, the remote machine 1 in which the VM is not operated may be operated from the terminal apparatuses 2a, 2b, and 2c.

In this manner, the image processing apparatus provided to the second information processing apparatus notifies the image display apparatuses provided to the first information processing apparatuses of the activation of the screen saver. Even if the screen saver is not activated by itself, it is possible to grasp that the screen saver is activated in the image display apparatuses provided with the first information processing apparatuses. For this reason, it is not necessary to activate the screen saver in the image processing apparatus, and the generation of the image data in the image processing apparatus can be stopped. As a result, it is possible to alleviate the resource consumption in the image processing apparatus during the operation of the screen saver.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

1. A computer apparatus for operating a virtual machine, the computer apparatus comprising:
a determination unit for determining, based upon operation information of a terminal apparatus operating the virtual machine, whether the virtual machine has activated a screen saver or has stoped the screen saver; and
a screen saver control information transmission unit for outputting control information to the terminal apparatus operating the virtual machine, on the basis of a determination result generated by the determination unit, the control information indicating that the terminal apparatus operating the virtual machine has activated the screen saver or has stopped the screen saver.

2. The computer apparatus according to claim 1, further comprising a drawing stop screen saver control unit for stopping drawing of image data displayed on the terminal apparatus on the basis of the determination result.

3. The computer apparatus according to claim 1, further comprising a resource release unit for requesting a Virtual Machine Monitor program to change a resource allocated to the virtual machine on the basis of the determination result.

4. The computer apparatus according to claim 1, further comprising a screen saver information saving unit for recording a waiting time until the screen saver is activated,
wherein the determination unit determines that the screen saver has been activated in a case where the operation information of the terminal apparatus is not yet received upon occurrence of an elapsing interval that equals or exceeds the waiting time recorded in the screen saver information saving unit.

5. A method executed by a computer apparatus for operating a virtual machine, the method comprising:
determining, based upon operation information of a terminal apparatus operating the virtual machine, whether the virtual machine has activated a screen saver or has stopped the screen saver; and
outputting control information to the terminal apparatus operating the virtual machine, on the basis of a determination result, the control information indicating that the terminal apparatus operating the virtual machine has activated the screen saver or has stopped the screen saver.

6. The method according to claim 5, further comprising stopping drawing of image data displayed on the terminal apparatus on the basis of the determination result.

7. The method according to claim 5, further comprising requesting a Virtual Machine Monitor program to change a resource allocated to the virtual machine on the basis of the determination result.

8. The method according to claim 5, further comprising recording a waiting time until the screen saver is activated the screen saver is activated in a screen saver information saving unit,
wherein the determining includes ascertaining that the screen saver is activated in a case where the operation information of the terminal apparatus is not yet received upon occurrence of an elapsing interval that equals or exceeds the waiting time recorded in the screen saver information saving unit.
